(19) United States
(12) Patent Application Publication
(10) Pub. No.: US 2006/0188098 A1
(43) Pub. Date: Aug. 24, 2006

(54) Encryption/decryption device, communication controller, and electronic instrument

(75) Inventors: Tomonori Kumagai, Sapporo-shi (JP); Nobuyuki Saito, Sapporo-shi (JP); Mitsuhiro Matsuo, Ebetsu-shi (JP)

Correspondence Address: OLIFF & BERRIDGE, PLC, P.O. BOX 19928, ALEXANDRIA, VA, 22320, US

(73) Assignee: SEIKO EPSON CORPORATION, TOKYO (JP)

(21) Appl. No.: 11/355,999

(22) Filed: Feb. 17, 2006

(30) Foreign Application Priority Data
Feb. 21, 2005 (JP) 2005-044395

(51) Int. Cl. H04N 7/167

(52) U.S. Cl. 380/239

(57) ABSTRACT

An encryption/decryption device includes an encryption/decryption processing section which performs encryption or decryption processing for divided data of first and second content data in an operation mode of a block cipher method using data in a block other than a block under processing, and an intermediate value storage section which stores a processing result or an input value of the encryption/decryption processing section in content units. After the processing result or the input value of the encryption/decryption processing section for one of the divided data of the second content data has been stored in the intermediate value storage section, the processing result or the input value for the Kth divided data of the first content data is read from the intermediate value storage section, and the encryption/decryption processing section performs the encryption or decryption processing for the (K+1)th divided data of the first content data by using the processing result or the input value.

Japanese Patent Application No. 2005-44395, filed on Feb. 21, 2005, is hereby incorporated by reference in its entirety.

### BACKGROUND OF THE INVENTION

The present invention relates to an encryption/decryption device, a communication controller, and an electronic instrument.

In recent years, digital broadcasting such as BS digital broadcasting which transmits an MPEG (Moving Picture Experts Group; MPEG2) stream has attracted attention, and electronic instruments such as a digital broadcast tuner and a digital broadcast recorder/player have been widely used. Therefore, copy prevention technology have been introduced in order to prevent unauthorized digital copying of content.

A digital broadcast tuner and a digital broadcast recorder/player are connected through a general-purpose high-speed serial interface represented by the Institute of Electrical and Electronics Engineers (IEEE) 1394, for example. As copy prevention technology for IEEE1394, the Digital Transmission Content Protect (DTCP) standard has been provided. At present, the DTCP standard is utilized as AV network copy prevention technology along with the spread of the Internet (e.g. DTCP over IP). The details of the DTCP standard are described in “Digital Transmission Content Protection Specification Volume 1 (Informational Version) (Revision 1.3, Jan. 7, 2004)”.

In the DTCP over IP standard, it is necessary to employ the US next-generation encryption algorithm called the Advanced Encryption Standard (AES) which replaces the Data Encryption Standard (DES). It is difficult to decipher content encrypted by using AES in comparison with DES. In DES, encryption or decryption processing is performed in units of 64-bit length blocks. In AES, encryption or decryption processing is performed in units of 128-bit length blocks, for example. A method of performing processing in block units, such as AES and DES, is called a block cipher method.

In the block cipher method, when the same data is input, the output data is also the same. In order to prevent such a decrease in cipher strength, various modes of operation (operation modes) are defined in the block cipher method. As the operation modes of the block cipher method, an electronic codebook (ECB) mode, a cipher block chaining (CBC) mode, a cipher feedback (CFB) mode, and an output feedback (OFB) mode are known. In the CBC mode, the CFB mode, and OFB mode excluding the ECB mode, different data can be output, even if the input data is the same, by utilizing data in a block other than the block under processing. On the other hand, when performing decryption processing in the CBC mode, the CFB mode, and the OFB mode, data in a block other than the block under processing is necessary.

As a device which performs encryption processing by using such a block cipher method, JP-A-2001-211149 discloses a device provided with data storage means which stores an initial vector, a processing intermediate value, or a processing final result in order to enable the CBC mode and the CFB mode.

JP-A-2000-75785 discloses a device which stores an intermediate value in block units in the CBC mode, and checks tampering of a message by using the intermediate value.

Content data utilizing the copy prevention technology specified in the DTCP over IP standard is transmitted and received between electronic instruments through a network. In this case, since the key is shared between authenticated devices, it is necessary to manage the key corresponding to the partner device.

The DTCP over IP standard specifies that the data size of content data must be 128 MB or less. Therefore, when receiving content data from two or more electronic instruments, it is necessary to divide the content data and use the key corresponding to the content data for processing the divided data.

However, in order to decrypt content data encrypted by using data in another block, such as in the CBC mode, the data in another block is necessary in decryption processing. Therefore, when using the technology disclosed in JP-A-2001-211149 or JP-A-2000-75785, decryption processing must be performed corresponding to the encryption processing unit of the supplier so that it is necessary to provide a buffer having a capacity of 128 MB, for example. Moreover, since decryption processing of content data cannot be performed during decryption processing of another content data, real-time properties of content data may be impaired.

### SUMMARY

According to a first aspect of the invention, there is provided an encryption/decryption device which performs encryption or decryption processing for divided data of first and second content data, the encryption/decryption device comprising:

an encryption/decryption processing section which performs encryption or decryption processing for the divided data in an operation mode of a block cipher method using data in a block other than a block under processing; and

an intermediate value storage section which stores a block-unit processing result or an input value of the encryption/decryption processing section in content units,

wherein, after the processing result or the input value of the encryption or decryption processing performed by the encryption/decryption processing section for one of the divided data of the second content data has been stored in the intermediate value storage section, the processing result or the input value for the Kth (K is a natural number) divided data of the first content data is read from the intermediate value storage section, and the encryption/decryption processing section performs the encryption or decryption processing for the (K+1)th divided data of the first content data by using the processing result or the input value.

According to a second aspect of the invention, there is provided an encryption/decryption device which performs encryption or decryption processing for divided data of first and second content data, the encryption/decryption device comprising:

a storage section which stores the divided data as input data and stores output data obtained by subjecting the input data to encryption or decryption processing;

a first encryption/decryption processing section which performs first encryption processing or first decryption processing for the divided data in an operation mode of a block cipher method using data in a block other than a block under processing;

a second encryption/decryption processing section which performs second encryption processing or second decryption processing for the divided data in an operation mode of a block cipher method using data in a block other than a block under processing; and

an intermediate value storage section which stores a block-unit processing result or an input value of the first and second encryption/decryption processing section in content units,

wherein the storage section stores decrypted data obtained by causing one of the first and second encryption/decryption processing sections to perform the first or second decryption processing for the input data;

wherein the storage section stores data obtained by causing the other of the first and second encryption/decryption processing sections to perform the first or second encryption processing for the decrypted data after the first or second encryption processing as the output data;

wherein the intermediate value storage section stores the processing result or the input value of the encryption or decryption processing performed by at least one of the first and second encryption/decryption processing sections for one of the divided data of the second content data as the input data; and

wherein the processing result or the input value of the first or second encryption/decryption processing section for the Kth (K is a natural number) divided data of the first content data is read from the intermediate value storage section, and at least one of the first and second encryption/decryption processing sections performs the encryption or decryption processing for the (K+1)th divided data of the first content data as the input data by using the processing result or the input value.

According to a third aspect of the invention, there is provided an encryption/decryption device which performs encryption or decryption processing for divided data of first and second content data, the encryption/decryption device comprising:

a first storage section which is accessible from outside of the encryption/decryption device and stores the divided data as input data;

a first encryption/decryption processing section which performs first encryption processing or first decryption processing for the divided data in an operation mode of a block cipher method using data in a block other than a block under processing;

a second encryption/decryption processing section which performs second encryption processing or second decryption processing for the divided data in an operation mode of a block cipher method using data in a block other than a block under processing;

a second storage section which is inaccessible from outside of the encryption/decryption device and stores decrypted data obtained by subjecting the input data to the first or second decryption processing;

a third storage section which is accessible from outside of the encryption/decryption device and stores output data obtained by subjecting the input data to the encryption or decryption processing; and

an intermediate value storage section which stores a block-unit processing result or an input value of the encryption/decryption processing section in content units,

wherein the second storage section stores decrypted data obtained by causing one of the first and second encryption/decryption processing sections to perform the first or second decryption processing for the input data;

wherein the third storage section stores data obtained by causing the other of the first and second encryption/decryption processing sections to perform the first or second encryption processing for the decrypted data after the first or second encryption processing as the output data;

wherein the intermediate value storage section stores the processing result or the input value of the encryption or decryption processing performed by at least one of the first and second encryption/decryption processing sections for one of the divided data of the second content data as the input data; and

wherein the processing result or the input value of the first or second encryption/decryption processing section for the Kth (K is a natural number) divided data of the first content data is read from the intermediate value storage section, and at least one of the first and second encryption/decryption processing sections performs the encryption or decryption processing for the (K+1)th divided data of the first content data as the input data by using the processing result or the input value.

According to a fourth aspect of the invention, there is provided a communication controller for transmitting and receiving communication data having a layered structure through a network, the communication controller comprising:

a communication processing section which performs transmission processing and reception processing of the communication data; and

any of the above-described encryption/decryption devices which performs the encryption or decryption processing for the communication data to be transmitted to the network or the communication data received from the network.

According to a fifth aspect of the invention, there is provided a communication controller for transmitting and receiving communication data having a layered structure through a network, the communication controller comprising:

a communication processing section which performs transmission processing and reception processing of the communication data; and

any of the above-described encryption/decryption devices,

wherein, when the communication data is received, the communication processing section analyzes header information, and the encryption/decryption device performs the first decryption processing and then the second encryption processing for data in a layer higher than a layer of the header information as the input data, and then outputs the data as the output data, the first encryption processing having been performed for the data before reception; and

wherein, when the communication data is to be transmitted, the encryption/decryption device performs the second decryption processing and then the first encryption processing for data to be transmitted as the input data, and then outputs the data as the output data, the communication processing section adds higher-layer header information to the output data, and then the communication controller transmits the resulting output data to the network.

According to a sixth aspect of the invention, there is provided an electronic instrument comprising:

any of the above-described communication controllers; and

a processing section which supplies divided content data to the communication controller.

According to a seventh aspect of the invention, there is provided an electronic instrument comprising:

the above-described communication controller; and

a processing section which generates divided content data and performs the second encryption processing and the second decryption processing,

wherein, when the communication data is received, the communication controller supplies data after the second encryption processing to the processing section; and

wherein, when the communication data is to be transmitted, the processing section supplies data after the second encryption processing to the communication controller as the input data.

### BRIEF DESCRIPTION OF THE SEVERAL VIEWS OF THE DRAWING

FIG. 1 is a diagram showing a configuration example of a communication system including an encryption/decryption device according to first and second embodiments.

FIG. 2 shows the major portion of a configuration of an electronic instrument shown in FIG. 1.

FIG. 3 shows an example of processing compliant with the DTCP standard performed between the electronic instruments shown in FIG. 1 or 2.

FIG. 4 shows a configuration example of various packets used in the communication system shown in FIG. 1 or 2.

FIG. 5 is a diagram showing a sequence of an example of content data reception processing in the communication system shown in FIG. 1 or 2.

FIG. 6 is a diagram showing a sequence of an example of content data transmission processing in the communication system shown in FIG. 1 or 2.

FIGS. 7A and 7B are illustrative of division of content data.

FIG. 8 is illustrative of first and second content data encrypted or decrypted in the CBC mode.

FIG. 9 is illustrative of first and second content data encrypted or decrypted in the CBC mode in the encryption/decryption device according to the first embodiment.

FIG. 10 is a block diagram showing a configuration example of the encryption/decryption device according to the first embodiment.

FIG. 11 shows an example of data stored in a key memory shown in FIG. 10.

FIGS. 12A and 12B are flow diagrams showing an outline of processing of an AES processing section.

FIG. 13A is illustrative of the CBC mode, FIG. 13B is illustrative of the CFB mode, and FIG. 13C is illustrative of the OFB mode.

FIG. 14 is illustrative of the encryption operation using the key memory in the CBC mode according to the first embodiment.

FIG. 15 is illustrative of the decryption operation using the key memory in the CBC mode according to the first embodiment.

FIG. 16 is illustrative of the encryption operation using the key memory in the CFB mode according to the first embodiment.

FIG. 17 is illustrative of the operation using the key memory in the OFB mode according to the first embodiment.

FIG. 18 is illustrative of a COM header according to the first embodiment.

FIG. 19 is illustrative of a PCPExtend header and a PCP header according to the first embodiment.

FIG. 20 is illustrative of processing of a state control section shown in FIG. 10.

FIG. 21 is a block diagram showing a configuration example of the encryption/decryption device according to the second embodiment.

FIG. 22 shows an example of data stored in a key memory shown in FIG. 21.

FIG. 23 is a flow diagram showing an outline of processing of a DES processing section.

FIG. 24 shows a configuration example of a storage section shown in FIG. 21, in which each storage area is set to be variable.

FIG. 25 is illustrative of processing of a state control section shown in FIG. 21.

FIG. 26 is illustrative of a COM header according to the second embodiment.

FIG. 27 is illustrative of a TranTYPE field shown in FIG. 26.

FIGS. 28A to 28D are illustrative of an operation mode corresponding to information set in the TranTYPE field.

FIGS. 29A to 29C are illustrative of an operation mode corresponding to information set in the TranTYPE field.

FIG. 30 is illustrative of an operation mode corresponding to information set in the TranTYPE field.

FIG. 31 shows a sequence in a program decryption mode.

FIG. 32 is a diagram illustrative of the operation in a modification.

### DETAILED DESCRIPTION OF THE EMBODIMENT

The invention may provide an encryption/decryption device, a communication controller, and an electronic instrument which perform encryption and decryption processing of a plurality of pieces of content data without impairing real-time properties.

According to one embodiment of the invention, there is provided an encryption/decryption device which performs encryption or decryption processing for divided data of first and second content data, the encryption/decryption device comprising:

an encryption/decryption processing section which performs encryption or decryption processing for the divided data in an operation mode of a block cipher method using data in a block other than a block under processing; and

an intermediate value storage section which stores a block-unit processing result or an input value of the encryption/decryption processing section in content units,

wherein, after the processing result or the input value of the encryption or decryption processing performed by the encryption/decryption processing section for one of the divided data of the second content data has been stored in the intermediate value storage section, the processing result or the input value for the Kth (K is a natural number) divided data of the first content data is read from the intermediate value storage section, and the encryption/decryption processing section performs the encryption or decryption processing for the (K+1)th divided data of the first content data by using the processing result or the input value.

In this encryption/decryption device,

a key, an initial value, and the processing result or the input value of the encryption/decryption processing section may be stored in the intermediate value storage section in content units.

In this embodiment, the encryption/decryption processing section processes the divided data in the operation mode of the block cipher method using data in a block other than the block under processing, and the processing result of the encryption/decryption processing section or the input value is stored in the intermediate value storage section. Therefore, even if the encryption or decryption processing of the first content data is interrupted, the encryption or decryption processing can be performed by reading the processing result or the input value from the intermediate value storage section and utilizing the processing result or the input value in the processing of another piece of the divided data of the first content data. This maintains the real-time properties of the encryption or decryption processing of a plurality of pieces of content data. Moreover, the capacity of the memory for buffering the divided data can be significantly reduced.

According to one embodiment of the invention, there is provided an encryption/decryption device which performs encryption or decryption processing for divided data of first and second content data, the encryption/decryption device comprising:

a storage section which stores the divided data as input data and stores output data obtained by subjecting the input data to encryption or decryption processing;

a first encryption/decryption processing section which performs first encryption processing or first decryption processing for the divided data in an operation mode of a block cipher method using data in a block other than a block under processing;

a second encryption/decryption processing section which performs second encryption processing or second decryption processing for the divided data in an operation mode of a block cipher method using data in a block other than a block under processing; and

an intermediate value storage section which stores a block-unit processing result or an input value of the first and second encryption/decryption processing section in content units,

wherein the storage section stores decrypted data obtained by causing one of the first and second encryption/decryption processing sections to perform the first or second decryption processing for the input data;

wherein the storage section stores data obtained by causing the other of the first and second encryption/decryption processing sections to perform the first or second encryption processing for the decrypted data after the first or second encryption processing as the output data;

wherein the intermediate value storage section stores the processing result or the input value of the encryption or decryption processing performed by at least one of the first and second encryption/decryption processing sections for one of the divided data of the second content data as the input data; and

wherein the processing result or the input value of the first or second encryption/decryption processing section for the Kth (K is a natural number) divided data of the first content data is read from the intermediate value storage section, and at least one of the first and second encryption/decryption processing sections performs the encryption or decryption processing for the (K+1)th divided data of the first content data as the input data by using the processing result or the input value.

In this encryption/decryption device,

a storage area for the decrypted data in the storage section may be inaccessible from outside of the encryption/decryption device.

According to one embodiment of the invention, there is provided an encryption/decryption device which performs encryption or decryption processing for divided data of first and second content data, the encryption/decryption device comprising:

a first storage section which is accessible from outside of the encryption/decryption device and stores the divided data as input data;

a first encryption/decryption processing section which performs first encryption processing or first decryption processing for the divided data in an operation mode of a block cipher method using data in a block other than a block under processing;

a second encryption/decryption processing section which performs second encryption processing or second decryption processing for the divided data in an operation mode of a block cipher method using data in a block other than a block under processing;

a second storage section which is inaccessible from outside of the encryption/decryption device and stores decrypted data obtained by subjecting the input data to the first or second decryption processing;

a third storage section which is accessible from outside of the encryption/decryption device and stores output data obtained by subjecting the input data to the encryption or decryption processing; and

an intermediate value storage section which stores a block-unit processing result or an input value of the encryption/decryption processing section in content units,

wherein the second storage section stores decrypted data obtained by causing one of the first and second encryption/decryption processing sections to perform the first or second decryption processing for the input data;

wherein the third storage section stores data obtained by causing the other of the first and second encryption/decryption processing sections to perform the first or second encryption processing for the decrypted data after the first or second encryption processing as the output data;

wherein the intermediate value storage section stores the processing result or the input value of the encryption or decryption processing performed by at least one of the first and second encryption/decryption processing sections for one of the divided data of the second content data as the input data; and

wherein the processing result or the input value of the first or second encryption/decryption processing section for the Kth (K is a natural number) divided data of the first content data is read from the intermediate value storage section, and at least one of the first and second encryption/decryption processing sections performs the encryption or decryption processing for the (K+1)th divided data of the first content data as the input data by using the processing result or the input value.

These embodiments of the invention also includes an encryption/decryption device including three or more encryption/decryption processing sections.

In any of these embodiments, the encryption/decryption processing section processes the divided data in the operation mode of the block cipher method using data in a block other than the block under processing, and the processing result of the encryption/decryption processing section or the input value is stored in the intermediate value storage section. Therefore, even if the encryption or decryption processing of the first content data is interrupted, the encryption or decryption processing can be performed by reading the processing result or the input value from the intermediate value storage section and utilizing the processing result or the input value in the processing of another piece of the divided data of the first content data. This maintains the real-time properties of the encryption or decryption processing of a plurality of pieces of content data. Moreover, the capacity of the memory for buffering the divided data can be significantly reduced.

In any of these embodiments, data after the first or second encryption processing is input to and output from the encryption/decryption device. The decrypted data obtained by subjecting the input data to the first or second decryption processing is buffered in the storage area inaccessible from the outside of the encryption/decryption device. Therefore, in any of these embodiments, the processing load of the processing section which sets the input data in the encryption/decryption device can be reduced by the first and second encryption/decryption processing sections, and encrypted data can be transferred between the encryption/decryption device and the processing section. Therefore, throughput of the processing section can be increased while preventing unauthorized digital copying of data, so that an encryption/decryption device which realizes content encryption and decryption processing at high speed can be provided.

In these encryption/decryption devices,

the first to third storage sections may be respectively provided in divided storage areas in one memory space; and

each of the storage areas may be variable.

In these embodiments, since the storage area of each storage section can be set corresponding to the processing unit of the first encryption and decryption processing and the second encryption and decryption processing, the storage area of the storage section can be effectively utilized.

In these encryption/decryption devices,

a key of the first encryption/decryption processing section, an initial value of the first encryption/decryption processing section, and the processing result or the input value of the first encryption/decryption processing section may be stored in the intermediate value storage section in content units; and

the processing result or the input value of the second encryption/decryption processing section may be stored in the intermediate value storage section in content units.

In these encryption/decryption devices,

a key of the first encryption/decryption processing section, an initial value of the first encryption/decryption processing section, and the processing result or the input value of the first encryption/decryption processing section may be stored in the intermediate value storage section in content units; and

the second encryption/decryption processing section may perform the second encryption processing or the second decryption processing for the (K+1)th divided data of the first content data as the input data by using a predetermined initial value without reading the processing result or the input value of the second encryption processing or the second decryption processing for the Kth divided data of the first content data from the intermediate value storage section.

In these embodiments, since it is unnecessary to store the processing result of the second encryption or decryption processing or the input value in the intermediate value storage section, the resource can be effectively utilized.

In these encryption/decryption devices,

the first encryption/decryption processing section may perform encryption and decryption processing compliant with the Advanced Encryption Standard (AES); and the second encryption/decryption processing section may perform encryption and decryption processing compliant with the Data Encryption Standard (DES).

In these encryption/decryption devices,

the operation mode may be one of the cipher block chaining (CBC) mode, the cipher feedback (CFB) mode, and the output feedback (OFB) mode.

Any of these encryption/decryption devices may comprise:

a header analysis section which analyzes header information added to the input data,

wherein whether the divided data is the divided data of the first content data or the divided data of the second content data is determined based on identification information included in the header information.

In these embodiments, since the encryption processing and the decryption processing can be controlled based on the header information, the configuration and control of the encryption/decryption device can be simplified.

According to one embodiment of the invention, there is provided a communication controller for transmitting and receiving communication data having a layered structure through a network, the communication controller comprising:

a communication processing section which performs transmission processing and reception processing of the communication data; and

any of the above-described encryption/decryption devices which performs the encryption or decryption processing for the communication data to be transmitted to the network or the communication data received from the network.

According to one embodiment of the invention, there is provided a communication controller for transmitting and receiving communication data having a layered structure through a network, the communication controller comprising:

a communication processing section which performs transmission processing and reception processing of the communication data; and

any of the above-described encryption/decryption devices,

wherein, when the communication data is received, the communication processing section analyzes header information, and the encryption/decryption device performs the first decryption processing and then the second encryption processing for data in a layer higher than a layer of the header information as the input data, and then outputs the data as the output data, the first encryption processing having been performed for the data before reception; and

wherein, when the communication data is to be transmitted, the encryption/decryption device performs the second decryption processing and then the first encryption processing for data to be transmitted as the input data, and then outputs the data as the output data, the communication processing section adds higher-layer header information to the output data, and then the communication controller transmits the resulting output data to the network.

In these embodiments, a communication controller including an encryption/decryption device which performs encryption and decryption processing of content data without impairing the real-time properties can be provided.

According to one embodiment of the invention, there is provided an electronic instrument comprising:

any of the above-described communication controllers; and

a processing section which supplies divided content data to the communication controller.

According to one embodiment of the invention, there is provided an electronic instrument comprising:

the above-described communication controller; and

a processing section which generates divided content data and performs the second encryption processing and the second decryption processing,

wherein, when the communication data is received, the communication controller supplies data after the second encryption processing to the processing section; and

wherein, when the communication data is to be transmitted, the processing section supplies data after the second encryption processing to the communication controller as the input data.

In these embodiments, an electronic instrument including an encryption/decryption device which performs encryption and decryption processing of content data without impairing the real-time properties can be provided.

These embodiments of the invention will be described in detail below, with reference to the drawings. Note that the embodiments described below do not in any way limit the scope of the invention laid out in the claims herein. In addition, not all of the elements of the embodiments described below should be taken as essential requirements of the invention.

1. Communication System

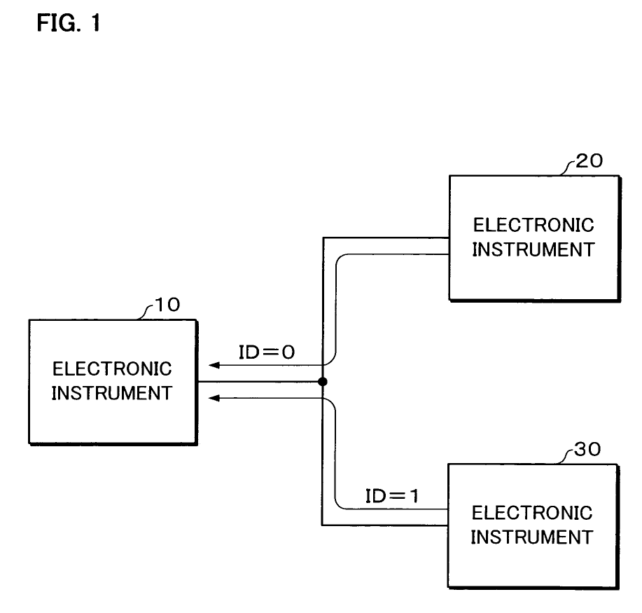

FIG. 1 shows a configuration example of a communication system including an encryption/decryption device according to an embodiment of the invention described later.

The communication system includes electronic instruments 10, 20, and 30 which transmit and receive communication data including digital content. The electronic instruments 10, 20, and 30 are connected through a network. In order to prevent unauthorized copying, intercepting, and tampering of content data, content data encrypted according to an algorithm compliant with the DTCP standard is transmitted and received between the electronic instruments 10, 20, and 30. Therefore, a content key is shared after the electronic instruments have been authenticated. For example, the electronic instrument 10 must separately manage the content key shared between the electronic instruments 10 and 20 when the electronic instruments 10 and 20 have been authenticated and the content key shared between the electronic instruments 10 and 30 when the electronic instruments 10 and 30 have been authenticated. In FIG. 1, identification information ID of first content data transmitted and received between the authenticated electronic instruments 10 and 20 is “0”, and identification information ID of second content data transmitted and received between the authenticated electronic instruments 10 and 30 is “1”.

In FIG. 1, the electronic instruments 10, 20, and 30 are connected through an Ethernet (registered trademark) cable, and transmit and receive communication data having a layered structure. However, the electronic instruments 10, 20, and 30 may transmit and receive communication data having a layered structure through a wireless network.

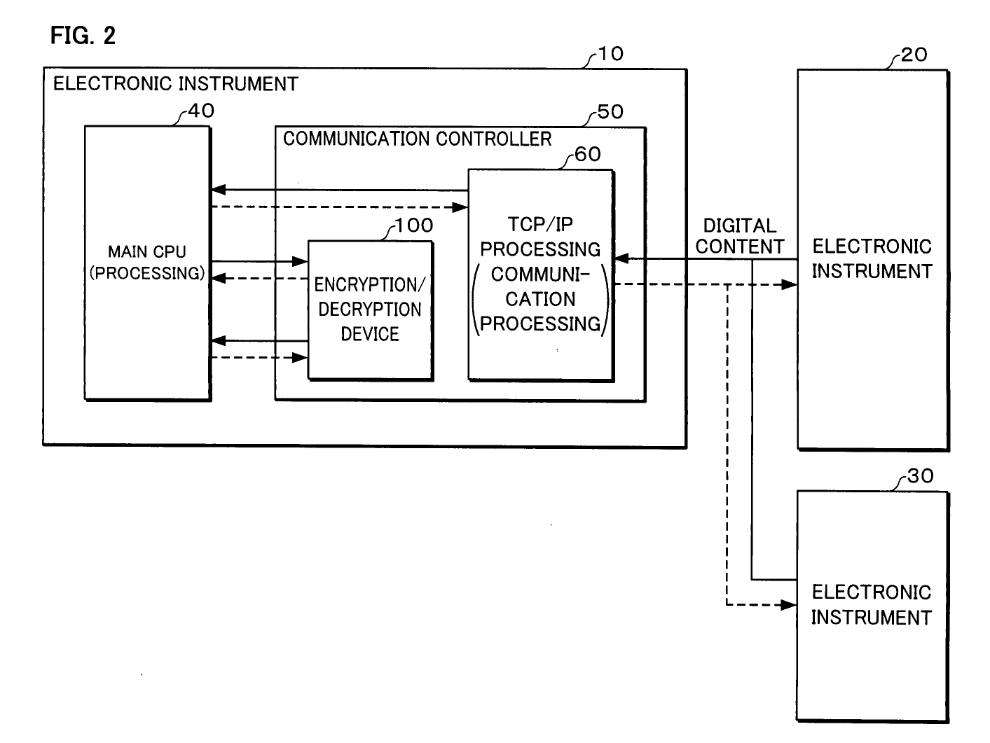

FIG. 2 shows the major portion of the configuration of the electronic instrument 10 shown in FIG. 1.

FIG. 1 shows only the configuration of the electronic instrument 10. Note that the electronic instruments 20 and 30 may have a configuration similar to the configuration of the electronic instrument 10.

In FIG. 2, the electronic instrument 10 includes a main central processing unit (CPU) (processing section in a broad sense) 40 and a communication controller (network controller) 50. The main CPU 40 controls the entire electronic instrument 10. The communication controller 50 transmits and receives communication data transmitted and received through an Ethernet cable.

The communication controller 50 includes a Transmission Control Protocol/Internet Protocol (TCP/IP) processing section (communication processing section in a broad sense) 60 which operates as a higher-layer analysis section, and an encryption/decryption device (encryption and decryption device or encryption-decryption device) 100.

The TCP/IP processing section 60 generates and analyzes a TCP/IP header added to content data transferred through an Ethernet cable.

The encryption/decryption device 100 performs encryption and decryption processing according to the AES algorithm specified in the DTCP standard to reduce the processing load of the main CPU 40. In order to prevent unauthorized copying of content data transferred between the encryption/decryption device 100 and the main CPU 40, it is desirable to take unauthorized copy prevention measures, such as transferring the content data in an encrypted state, covering a signal line provided between the encryption/decryption device 100 and the main CPU 40 with a resin or the like, or providing the signal line inside a mounting substrate. When transferring encrypted content data between the encryption/decryption device 100 and the main CPU 40, the encryption/decryption device 100 may perform encryption and decryption processing according to an algorithm predetermined between the encryption/decryption device 100 and the main CPU 40 in addition to AES encryption and decryption processing. In this case, the encryption/decryption device 100 may perform encryption and decryption processing according to the DES algorithm when transferring data between the encryption/decryption device 100 and the main CPU 40.

1.1 DTCP

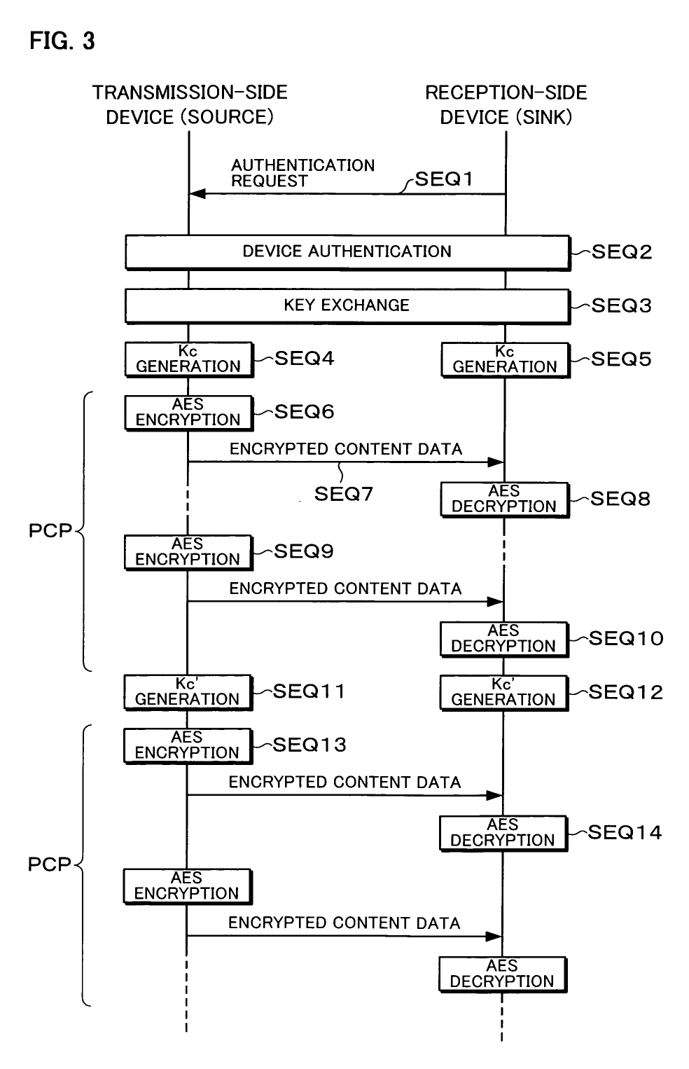

FIG. 3 shows an example of processing compliant with the DTCP standard performed between the electronic instruments shown in FIG. 1.

In the DTCP standard, authentication processing is performed between a content data transmission-side device called a source and a content data reception-side device called a sink, and a content key Kc is shared between the authenticated devices.

Specifically, the reception-side device requests authentication from the transmission-side device in order to decrypt encrypted content data (SEQ1).

This allows device authentication to be performed between the source and the sink (SEQ2). The device authentication is divided into Full Authentication using public key cryptography and Restricted Authentication using common key cryptography, and is selectively used depending on copy control information of content data, characteristics of the device, and the like. For example, in the DTCP over IP standard used to protect content data transferred through an Ethernet cable, only Full Authentication is permitted.

When each device has authenticated the partner device as a result of device authentication, keys are exchanged (SEQ3). As a result, a random number Nc and an exchange key Kx are shared between the devices. Each device independently generates a content key Kc by using a function shown by the following expression (SEQ4 and SEQ5).
Kc=Func(Kx,C,Nc) (1)

Each device calculates the content key Kc by using the predetermined function Func( ) and the constant C.

The transmission-side device encrypts content data according to the AES algorithm by using the content key Kc, and transmits the encrypted content data to the reception-side device (SEQ6 and SEQ7). The reception-side device decrypts the received content data by using the content key Kc to acquire the content data.

The authenticated devices then transmit and receive content data in the same manner as described above by encrypting and decrypting content data using the content key Kc.

The content data is transmitted and received between the transmission-side device and the reception-side device in units of protected content packets (PCP), and the key is updated in PCP units.

Therefore, when encryption and decryption processing by using the content key Kc has been completed (SEQ9 and SEQ10), the transmission-side device updates the content key Kc upon completion of encryption processing of content data in PCP units. The reception-side device updates the content key Kc upon completion of decryption processing of content data in PCP units. The transmission-side device and the reception-side device generate updated content keys Kc′ by using a function shown by the following expression (SEQ11 and SEQ12).
Kc′=Func(Kx,C,Nc+1) (2)

Then, the transmission-side device encrypts content data according to the AES algorithm by using the content key Kc′, and transmits the encrypted content data to the reception-side device (SEQ13). The reception-side device decrypts the received content data by using the content key Kc′ to acquire the content data (SEQ14).

The authenticated devices then transmit and receive content data in the same manner as described above by encrypting and decrypting content data in PCP units by using the content key Kc′.

The details of the DTCP standard are described in “Digital Transmission Content Protection Specification Volume 1 (Informational Version) (Revision 1.3, Jan. 7, 2004)” and “DTCP Volume 1 Supplement E Mapping DTCP to IP (Informational Version) (Revision 1.0, Nov. 24, 2003)”.

In FIG. 2, the authentication processing may be performed by the main CPU 40, and the AES encryption and decryption processing (including content key generation) may be performed by the encryption/decryption device 100. An accelerator may be provided inside or outside the encryption/decryption device 100, and the accelerator may perform the authentication processing.

1.2 Outline of Operation

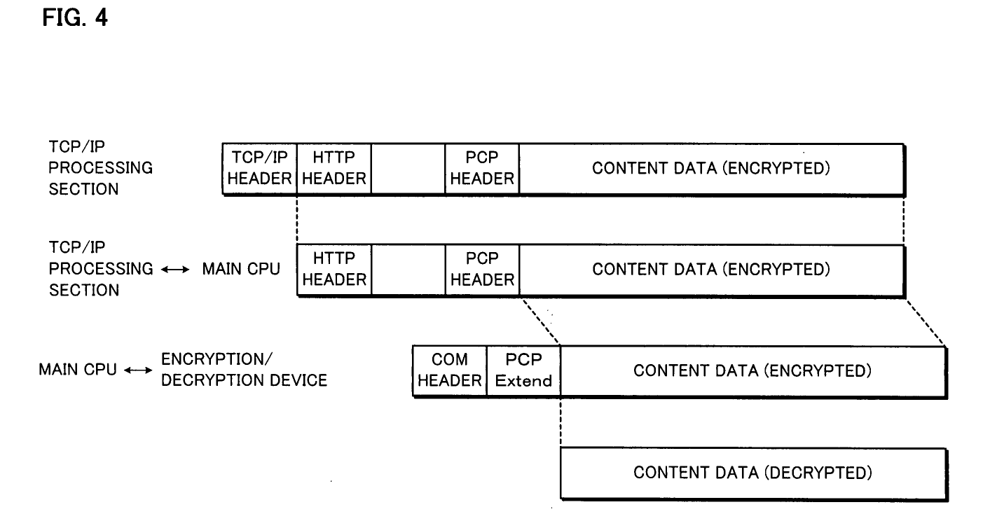

FIG. 4 shows a configuration example of various packets used in the communication system shown in FIGS. 1 and 2.

A packet received by the electronic instrument 10 (reception-side device) through an Ethernet cable is data in which a PCP header, a Hypertext Transfer Protocol (HTTP) header, and a TCP/IP header are added to content data encrypted according to AES. The TCP/IP processing section 60 analyzes the destination of the TCP/IP header or generates and adds the TCP/IP header.

The data in a layer higher than the layer to which the TCP/IP header is added is transferred between the main CPU 40 and the TCP/IP processing section 60. The main CPU 40 analyzes the HTTP header or generates and adds the HTTP header. The main CPU 40 generates a COM header for controlling the encryption/decryption device 100. The main CPU 40 generates a PCPExtend header by extending the PCP header, and supplies packet data, in which the PCPExtend header and the COM header are added to the encrypted content data, to the encryption/decryption device 100. The PCPExtend header includes the entire information of the PCP header.

The encryption/decryption device 100 performs encryption and decryption processing in order to transmit and receive encrypted content data to and from the main CPU 40. In more detail, when the encryption/decryption device 100 transmits and receives content data transmitted and received to and from the TCP/IP processing section 60 through the main CPU 40, the encryption/decryption device 100 transmits and receives content data encrypted according to the AES algorithm specified in the DTCP standard to and from the main CPU 40. When the encryption/decryption device 100 transmits and receives content data transmitted and received to and from the main CPU 40 without being supplied to the TCP/IP processing section 60, the encryption/decryption device 100 transmits and receives content data encrypted according to an algorithm predetermined between the encryption/decryption device 100 and the main CPU 40.

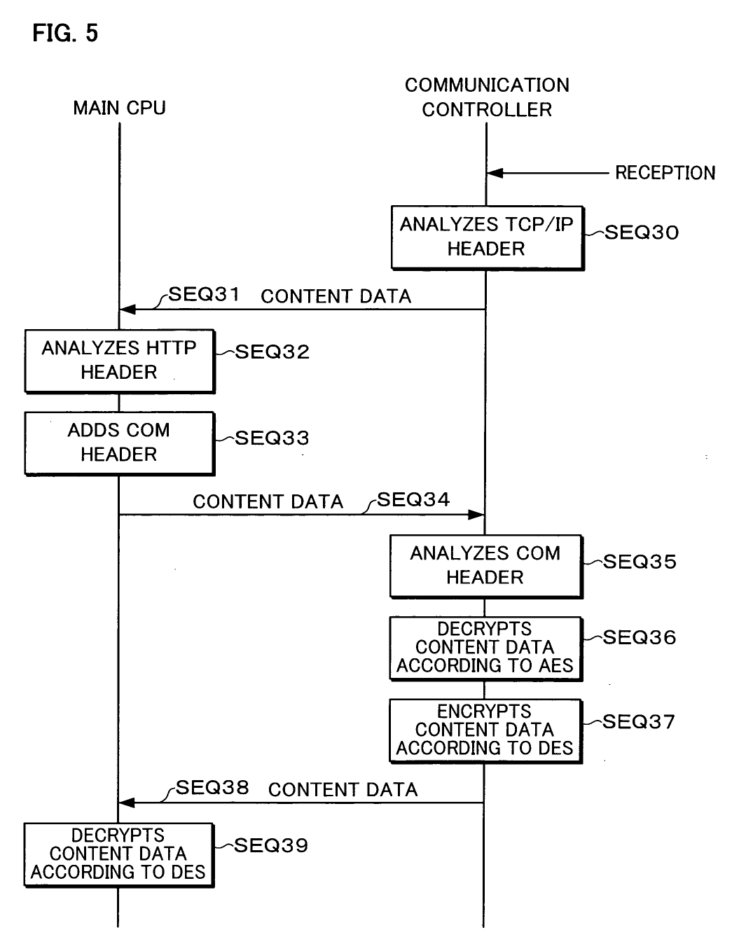

FIG. 5 shows a sequence of an example of content data reception processing in the communication system shown in FIGS. 1 and 2.

In this example, content data which is not supplied to the TCP/IP processing section 60 is encrypted according to the DES algorithm and transferred between the encryption/decryption device 100 and the main CPU 40.

The communication controller 50 receives a packet including content data encrypted according to the AES algorithm. The TCP/IP processing section 60 analyzes the sender and the recipient of the TCP/IP header of the packet (SEQ30). When the TCP/IP processing section 60 has determined that the recipient of the packet is the TCP/IP processing section 60, the TCP/IP processing section 60 supplies the data in a layer higher than the layer to which the TCP/IP header is added and information for identifying the sender and the recipient to the main CPU 40 (SEQ31).

The main CPU 40 analyzes the HTTP header as required (SEQ32), and determines the supplier of the content data based on the information transferred from the TCP/IP processing section 60. The main CPU 40 generates a COM header including identification information ID corresponding to the supplier, and generates a PCPExtend header including the PCP header. The main CPU 40 adds the PCPExtend header and the COM header to the content data (SEQ33), and transmits the content data to the encryption/decryption device 100 of the communication controller 50 (SEQ34).

The encryption/decryption device 100 analyzes the COM header (SEQ35). The encryption/decryption device 100 decrypts the content data according to the AES algorithm based on the analysis result (SEQ36), and encrypts the decrypted content data according to the DES algorithm (SEQ37). A key corresponding to the identification information ID of the COM header is used in the AES decryption processing. The content data encrypted according to the DES algorithm is transmitted to the main CPU 40 (SEQ38).

The main CPU 40 receives the content data encrypted according to the DES algorithm, and decrypts the content data according to the DES algorithm (SEQ39).

As described above, content data encrypted according to the AES or DES algorithm is transferred between the main CPU 40 and the communication controller 50 during the reception processing. Therefore, content data transmitted from the electronic instrument 20 or 30 can be acquired while preventing unauthorized copying of content data.

The encryption/decryption device 100 performs decryption processing according to the AES algorithm, which imposes a heavy load, in place of the main CPU 40. Encrypted content data is transferred between the main CPU 40 and the encryption/decryption device 100. However, since it suffices that the main CPU 40 perform decryption processing according to the DES algorithm, which imposes a low processing load in comparison with the AES algorithm, the processing performance of the main CPU 40 can be used for other processing, so that throughput can be improved.

The TCP/IP processing section 60 of the communication controller 50 analyzes the TCP/IP header and transfers the content data to the main CPU 40. The main CPU 40 then transfers the higher layer excluding the TCP/IP header to the encryption/decryption device 100 of the communication controller 50. Therefore, even if a middle layer is provided in the future between the layer to which the HTTP header is added and the layer to which the PCP header is added, it is possible to flexibly deal with such a situation without changing the hardware configuration. This is because the analysis function of such a middle layer can be easily added to the function of the main CPU 40 implemented by software.

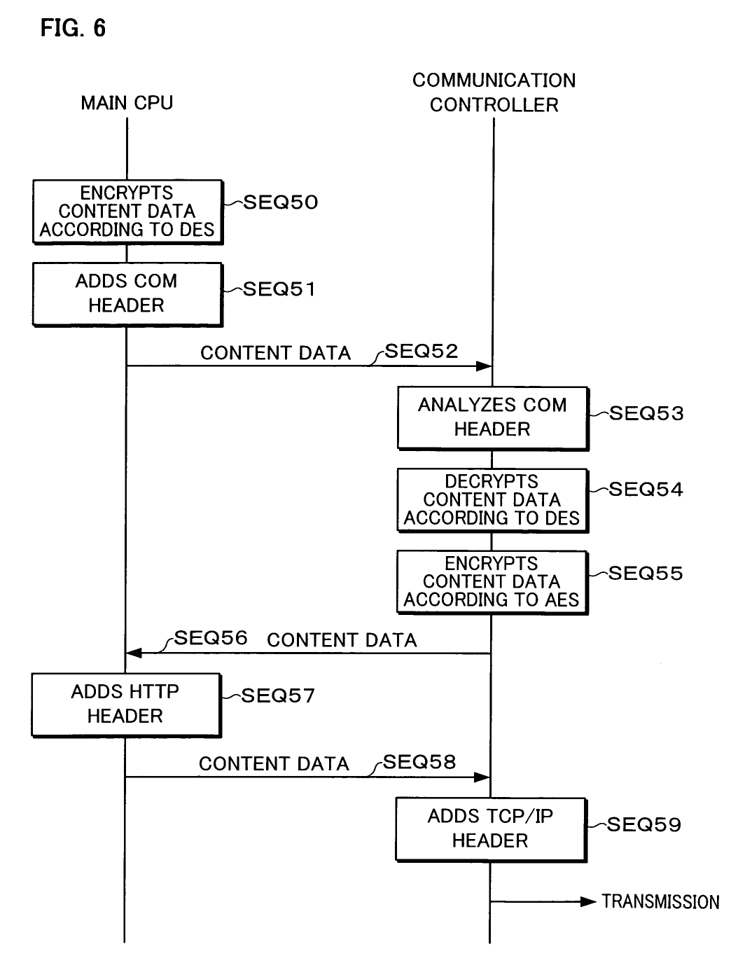

FIG. 6 shows a sequence of an example of content data transmission processing in the communication system shown in FIGS. 1 and 2.

In this example, content data which is not supplied to the TCP/IP processing section 60 is encrypted according to the DES algorithm and transferred between the encryption/decryption device 100 and the main CPU 40.

The main CPU 40 encrypts content data which it is desired to transmit to the electronic instrument 20 or 30 according to the DES algorithm (SEQ50). The main CPU 40 designates the identification information ID corresponding to the transmission destination. The main CPU 40 generates the PCPExtend header and the COM header including control information directing the encryption/decryption device 100 to perform decryption processing according to DES and encryption processing according to AES, and transmits the content data, to which the PCPExtend header and the COM header are added, to the communication controller 50 (SEQ51 and SEQ52).

The encryption/decryption device 100 of the communication controller 50 analyzes the COM header (SEQ53). The encryption/decryption device 100 decrypts the content data according to the DES algorithm based on the analysis result (SEQ54), and encrypts the decrypted content data according to the AES algorithm (SEQ55). A key corresponding to the identification information ID of the COM header is used in the AES encryption processing. The content data encrypted according to the AES algorithm is transmitted to the main CPU 40 (SEQ56).

The main CPU 40 creates an HTTP header and converts the PCPExtend header into a PCP header. The main CPU 40 adds the PCP header and HTTP header to the content data (SEQ57), and transmits the content data to the TCP/IP processing section 60 together with the identification information ID (SEQ58).

The TCP/IP processing section 60 adds the TCP/IP header specifying the transmission destination corresponding to the electronic instrument 20 or 30 (SEQ59), and transmits the content data to the electronic instrument 20 or 30.

As described above, content data encrypted according to the AES or DES algorithm is also transferred between the main CPU 40 and the communication controller 50 during the transmission processing. Therefore, the content data can be transmitted to the electronic instrument 20 or 30 while preventing unauthorized copying of the content data.

The encryption/decryption device 100 performs encryption processing according to the AES algorithm, which imposes a heavy load, in place of the main CPU 40. The main CPU 40 and the encryption/decryption device 100 transmit and receive encrypted content data. However, since it suffices that the main CPU 40 perform encryption processing according to the DES algorithm, which imposes a low processing load in comparison with the AES algorithm, the processing performance of the main CPU 40 can be used for other processing, so that throughput can be improved.

The encryption/decryption device 100 of the communication controller 50 encrypts content data according to the AES algorithm and transfers the encrypted content data to the main CPU 40. The main CPU 40 then transfers the encrypted content data to the TCP/IP processing section 60 of the communication controller 50. Therefore, even if a middle layer is provided in the future between the layer to which the HTTP header is added and the layer to which the PCP header is added, it is possible to flexibly deal with such a situation without changing the hardware configuration. This is because the header generation and addition function for such a middle layer can be easily added to the function of the main CPU 40 implemented by software.

1.3 Division of Content Data

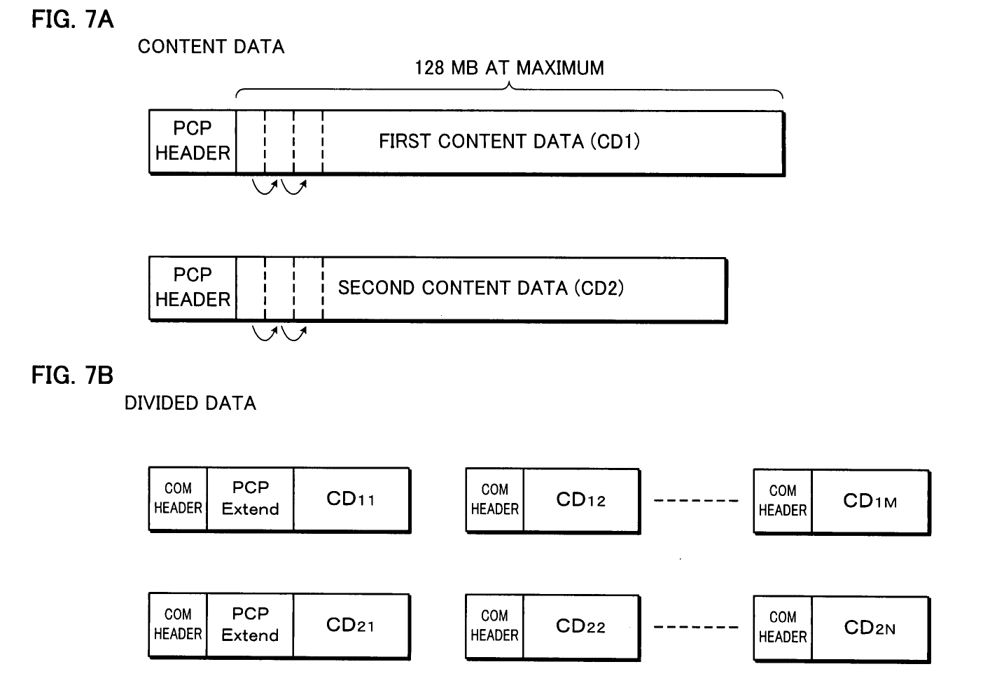

FIGS. 7A and 7B are diagrams illustrative of division of content data.

The DTCP over IP standard specifies that the data size of content data must be 128 MB or less. On the other hand, AES which is the block cipher method is employed in the DTCP over IP standard. Therefore, the main CPU 40 generates divided data by dividing content data, and supplies the divided data to the encryption/decryption device 100 as input data. The encryption/decryption device 100 performs AES encryption or decryption processing in units of 16 bytes.

When receiving a plurality of pieces of content data as shown in FIG. 1 or 2, the main CPU 40 provides the identification information ID to the content data, divides the content data, and supplies the divided data to the encryption/decryption device 100. In this case, the main CPU 40 divides the content data so that the divided data has a packet data size determined taking into consideration the block size of the block cipher method of the encryption/decryption device 100, the buffering size of the divided data, and the like.

When content data of which the identification information ID is “0” is first content data CD1, the main CPU 40 divides the first content data CD1 into M (M is an integer of two or more) pieces, and adds the COM header to each divided data. The PCPExtend header generated by extending the PCP header is added to only first divided data CD₁₁.

Likewise, when content data of which the identification information ID is “1” is second content data CD2, the main CPU 40 divides the second content data CD2 into N (N is an integer of two or more) pieces, and adds the COM header to each divided data. The PCPExtend header generated by extending the PCP header is added to only first divided data CD₂₁.

However, the DTCP over IP standard specifies the CBC mode as the operation mode of the block cipher method. Therefore, the first and second content data CD1 and CD2 is encrypted or decrypted in the CBC mode. Accordingly, even if the content data before encryption processing is the same, different data is obtained after encryption processing.

The operation mode of the block cipher method may be referred to as an operation mode using data in a block other than the block under processing. As examples of such an operation mode, the CBC mode, the CFB mode, and the OFB mode can be given. The encryption/decryption device 100 can operate in the ECB mode and the CBC mode of AES which is the block cipher method. The encryption/decryption device 100 may operate in all of or at least one of the CBC mode, the CFB mode, and the OFB mode excluding the ECB mode.

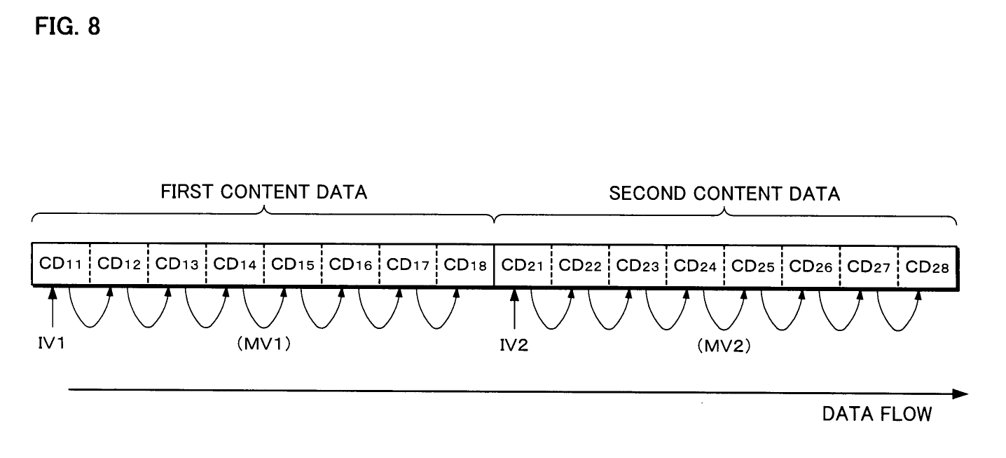

FIG. 8 is a diagram illustrative of the first and second content data encrypted or decrypted in the CBC mode.

In FIG. 8, the first content data CD1 is divided into eight pieces of divided data CD₁₁ to CD₁₈, and the second content data CD2 is divided into eight pieces of divided data CD₂₁ to CD₂₈. In this case, the divided data CD₁₁ is block-ciphered by using an initial value (initial vector) IV1, the divided data CD₁₂ is block-ciphered by using the divided data CD₁₁, and the divided data CD₁₃ is block-ciphered by using the divided data CD₁₂. Likewise, the divided data CD₂₁ is block-ciphered by using an initial value (initial vector) IV2, the divided data CD₂₂ is block-ciphered by using the divided data CD₂₁, and the divided data CD₂₃ is block-ciphered by using the divided data CD₂₂.

Therefore, in order to obtain the first content data CD1 after decryption processing, the divided data CD₁₁ to CD₁₈ of the first content data CD1 is necessary. Likewise, in order to obtain the second content data CD2 after decryption processing, the divided data CD₂₁ to CD₂₈ of the second content data CD2 is necessary.

Specifically, a situation may occur in which the encryption/decryption device 100 cannot start encryption and decryption processing of the second content data CD2 before encryption and decryption processing of the first content data CD1 is completed. In particular, when simultaneously receiving a plurality of pieces of content data from a plurality of electronic instruments through a network, decryption processing cannot be performed until the entire data encrypted by the supplier electronic instrument is complete. Therefore, the capacity of a memory in which the divided data is buffered must be increased, and the decryption processing requires longer processing time.

To deal with this problem, the encryption/decryption device 100 includes an intermediate value storage section which stores an encryption processing result calculated in block units by using the block encryption/decryption method or a decryption input value in content units.

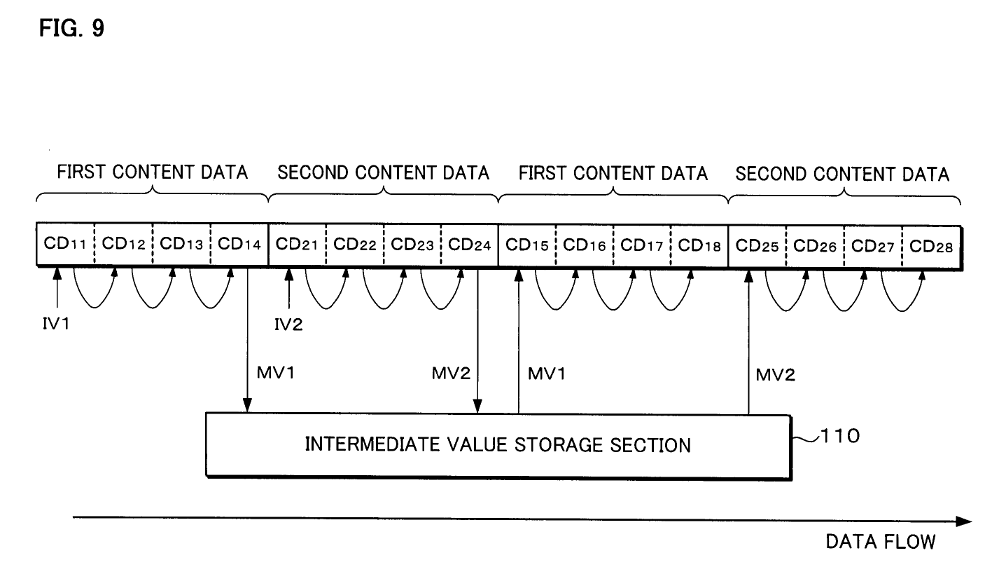

FIG. 9 is a diagram illustrative of the first and second content data encrypted or decrypted by the encryption/decryption device 100 in the CBC mode.

The encryption/decryption device 100 includes an intermediate value storage section 110. A block-unit encryption processing result or a decryption input value is stored in the intermediate value storage section 110 in content units. The encryption/decryption device 100 sequentially encrypts the divided data CD₁₁ to CD₁₈ of the first content data in the order from the divided data CD₁₁. After the encryption/decryption device 100 has encrypted the divided data CD₁₄, the encryption/decryption device 100 stores a processing result MV1 in the intermediate value storage section 110. Or, the encryption/decryption device 100 sequentially decrypts the divided data in the order from the divided data CD₁₁, and stores the divided data CD₁₄ (decryption input value) in the intermediate value storage section 110.

The encryption/decryption device 100 then starts encrypting or decrypting the second content data CD2. The encryption/decryption device 100 sequentially encrypts the divided data CD₂₁ to CD₂₈ of the second content data CD2 in the order from the divided data CD₂₁. After the encryption/decryption device 100 has encrypted the divided data CD₂₄ (one of the divided data of the second content data), the encryption/decryption device 100 stores a processing result MV2 in the intermediate value storage section 110. Or, the encryption/decryption device 100 sequentially decrypts the divided data in the order from the divided data CD₂₁, and stores the divided data CD₂₄ (decryption input value) in the intermediate value storage section 110.

The encryption/decryption device 100 then reads the processing result or input value MV1 for the divided data CD₁₄ (Kth (K is a natural number) divided data of the divided data CD₁₁ to CD₁₈ of the first content data CD1) from the intermediate value storage section 110, and encrypts or decrypts the divided data CD₁₅ ((K+1)th divided data of the divided data CD₁₁ to CD₁₈ of the first content data CD1) by using the processing result or input value MV1. The encryption/decryption device 100 then sequentially encrypts or decrypts the divided data CD₁₆ to CD₁₈.

The encryption/decryption device 100 then reads the processing result or input value MV2 for the divided data CD₂₄ from the intermediate value storage section 110, and encrypts or decrypts the divided data CD₂₅ by using the processing result or input value MV2. The encryption/decryption device 100 then sequentially encrypts or decrypts the divided data CD₂₆ to CD₂₈.

Therefore, the encryption/decryption device 100 allows a reduction in the capacity of the memory in which the divided data is buffered and a reduction in encryption or decryption processing time. As a result, the capacity of the memory for buffering content data (divided data) can be reduced, and real-time properties of content data can be maintained.

2. Encryption/Decryption Device

2.1 First Embodiment

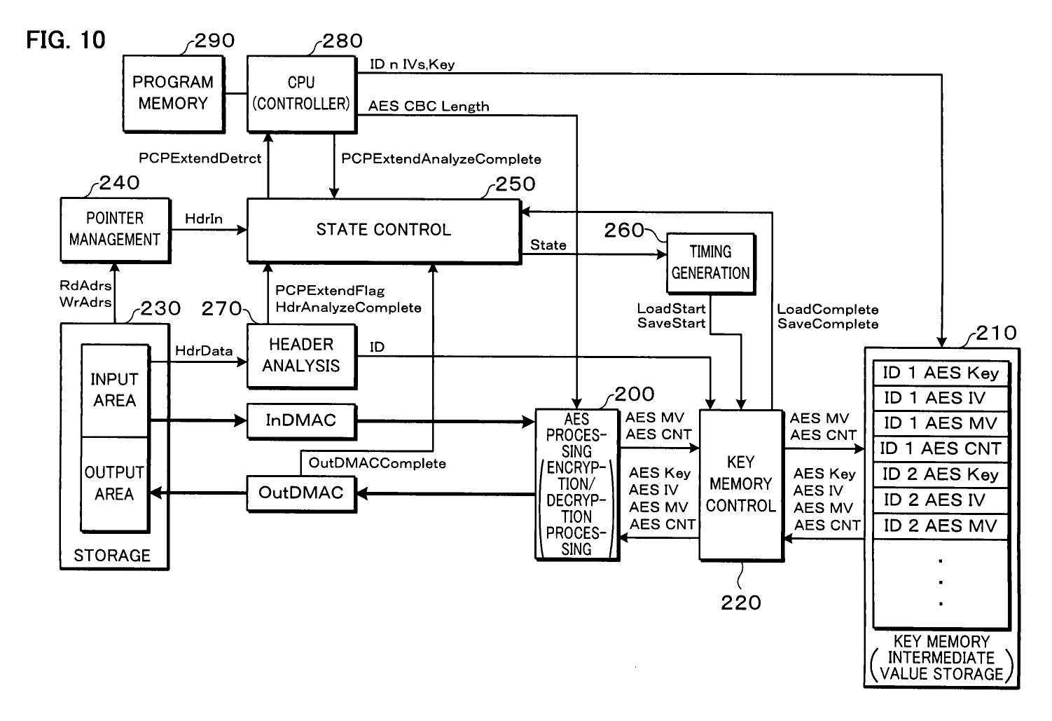

FIG. 10 is a block diagram of a configuration example of an encryption/decryption device according to a first embodiment.

The encryption/decryption device 100 may perform processing according to one encryption/decryption algorithm. In this configuration example, the encryption/decryption device 100 encrypts or decrypts the divided data of the first and second content data according to the AES algorithm.

The encryption/decryption device 100 includes an AES processing section 200 as the encryption/decryption processing section, and a key memory 210 as the intermediate value storage section 110. The AES processing section 200 encrypts or decrypts the divided data in the operation mode of the block cipher method using data in a block other than the block under processing. The key memory 210 stores the block-unit processing result of the AES processing section 200 in content units.

The function of the key memory 210 is implemented by a memory device such as a static random access memory (SRAM) or a dynamic random access memory (DRAM), a register circuit, a memory device having a First-In First-Out (FIFO) function, or the like.

The AES processing section 200 stores the encryption processing result or the decryption input value for one of the divided data CD₂₁ to CD₂₈ of the second content data CD2 in the key memory 210. The AES processing section 200 reads the processing result or the input value for the Kth divided data of the divided data CD₁₁ to CD₁₈ of the first content data CD1 from the key memory 210, and encrypts or decrypts the (K+1)th divided data of the divided data CD₁₁ to CD₁₈ by using the processing result.

In more detail, the key memory 210 stores the key, the initial value, and the processing result (intermediate value) of the AES processing section 200 in content units (in units of identification information corresponding to content data).

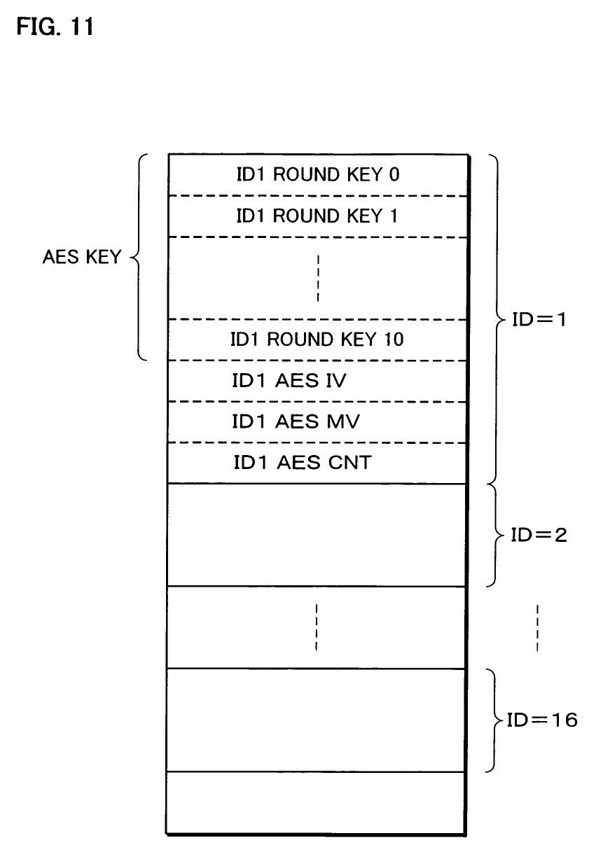

FIG. 11 shows an example of data stored in the key memory 210 shown in FIG. 10.

The key memory 210 stores information specific to content data in units of content distinguished by the identification information provided to the content data. The information specific to content data includes the AES key used in the AES processing section 200 to perform encryption or decryption processing, the initial value IV, the encryption processing result or decryption input value (intermediate value) MV, and a count value CNT. Since the AES key is changed in round units, the key in each round can be stored in the key memory 210. The initial value IV is an initial vector value used for the first block in the CBC mode of AES. The count value CNT is a value corresponding to the number of remaining blocks to be processed in the CBC mode of AES.

16 types of information specific to content data are stored in the key memory 210.

As shown in FIG. 10, the encryption/decryption device 100 includes a key memory control section 220 in order to access the key memory 210. The key memory control section 220 controls reading from the key memory 210 and writing into the key memory 210.

The encryption/decryption device 100 may include a storage section 230. The storage area of the storage section 230 includes an input area (InputArea) and an output area (OutputArea). The function of the storage section 230 is implemented by a memory device such as an SRAM or a DRAM, a register circuit, a memory device having a FIFO function, or the like.

When causing the encryption/decryption device 100 to perform encryption or decryption processing, the main CPU 40 sequentially sets divided data in the input area as input data. In the encryption/decryption device 100, an input data transfer InDMAC reads the divided data from the input area, and the AES processing section 200 encrypts or decrypts the divided data by using the block cipher method. Then, an output data transfer OutDMAC sequentially sets the processed data from the AES processing section 200 in the output area. The main CPU 40 sequentially acquires the data set in the output area of the storage section 230 as output data.

A write area and a read area of each area of the storage section 230 are managed by a pointer management section 240. In more detail, the pointer management section 240 sets and updates a write pointer and a read pointer of the input area and a write pointer and a read pointer of the output area. The write pointer designates the write area of each area. The read pointer designates the read area of each area.

Each section of the encryption/decryption device 100 is controlled by a state control section 250. The state control section 250 transitions between states defined in advance, and supplies a control signal corresponding to the state after transition to each section of the encryption/decryption device 100. A timing generation section 260 generates a read timing from the key memory 210 and a write timing into the key memory 210 based on the control signal from the state control section 250.

A COM header in which control information is stored is added to content data by the main CPU 40. The encryption/decryption device 100 includes a header analysis section 270. The header analysis section 270 analyzes the COM header. The header analysis section 270 distinguishes content data based on the identification information ID included in the COM header. Specifically, the header analysis section 270 can determine whether the input content data is the divided data of the first content data or the divided data of the second content data based on the identification information included in the header information. The key memory control section 220 generates a write address of information to be stored in the key memory 210 and a read address of information to be read from the key memory 210 based on the identification information ID. The key memory control section 220 reads the initial value IV corresponding to the identification information ID when the count value CNT is “0”, and reads the processing result or input value (intermediate value) MV corresponding to the identification information ID when the count value CNT is not “0”.

The encryption/decryption device 100 may include a central processing unit (hereinafter abbreviated as “CPU”) 280 as the controller. The CPU 280 executes processing corresponding to program data stored in a program memory 290, and generates and updates the AES key.

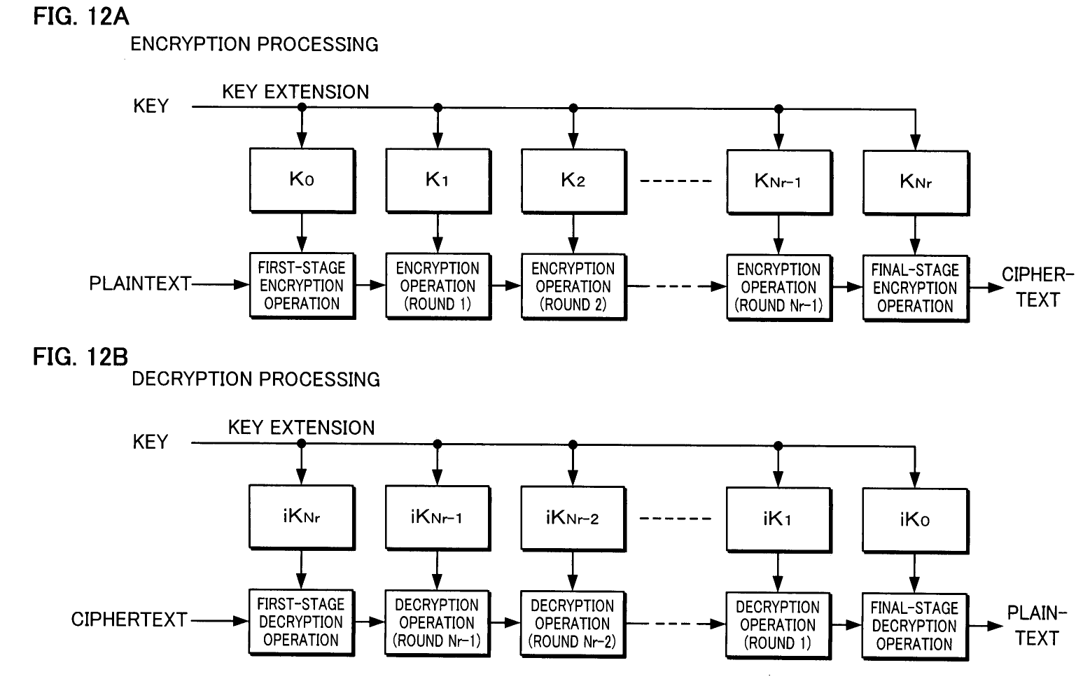

FIGS. 12A and 12B show the flow of processing of the AES processing section 200.

FIG. 12A shows an outline of encryption processing performed by the AES processing section 200. The CPU 280 performs extension processing based on the content key Kc acquired as described with reference to FIG. 3 to generate keys K₀, K₁, . . . , K_{Nr} in round units. The AES processing section 200 performs an encryption operation in block units (one block has a length corresponding to 128-bit input data (plaintext)) while changing the key in round units.

In the first-stage encryption operation, an AddRoundkey operation is performed by using the key K₀. A SubBytes operation, a ShiftRows operation, a MixColumns operation, and an AddRoundKey operation are performed from the round 1 to the round (Nr−1) by using the key in each round. In the final-stage encryption operation, the SubBytes operation, the ShiftRows operation, and the AddRoundkey operation are performed.

FIG. 12B shows an outline of decryption processing performed by the AES processing section 200. The CPU 280 performs extension processing based on the content key Kc acquired as described with reference to FIG. 3 to generate Keys iK_{Nr}, iK_{Nr-1}, . . . , IK₀ in round units. The AES processing section 200 performs a decryption operation in block units (one block has a length corresponding to 128-bit input data (ciphertext)) while changing the key in round units.

In the first-stage decryption operation, the AddRoundkey operation is performed by using the key iK_{Nr}. An InvShiftrows operation, an InvSubBytes operation, an AddRoundkey operation, and an InvMixColumns operation are performed in the period from the round (Nr−1) to the round 1 by using the key in each round. In the final-stage decryption operation, the InvShifRows operation, the InvSubBytes operation, and the AddRoundkey operation are performed.

The details of each operation in the encryption operation and the decryption operation are described in “Announcing the Advanced Encryption Standard (AES) (Nov. 26, 2001, FIPS PUB 197)”. Therefore, further description is omitted.

Since the AES processing section 200 repeatedly performs the same operations, the processing speed can be increased by implementing the processing of the AES processing section 200 by hardware.

2.1.1 Operation Mode of Block Cipher Method

The operation mode of the block cipher method is described below in detail.

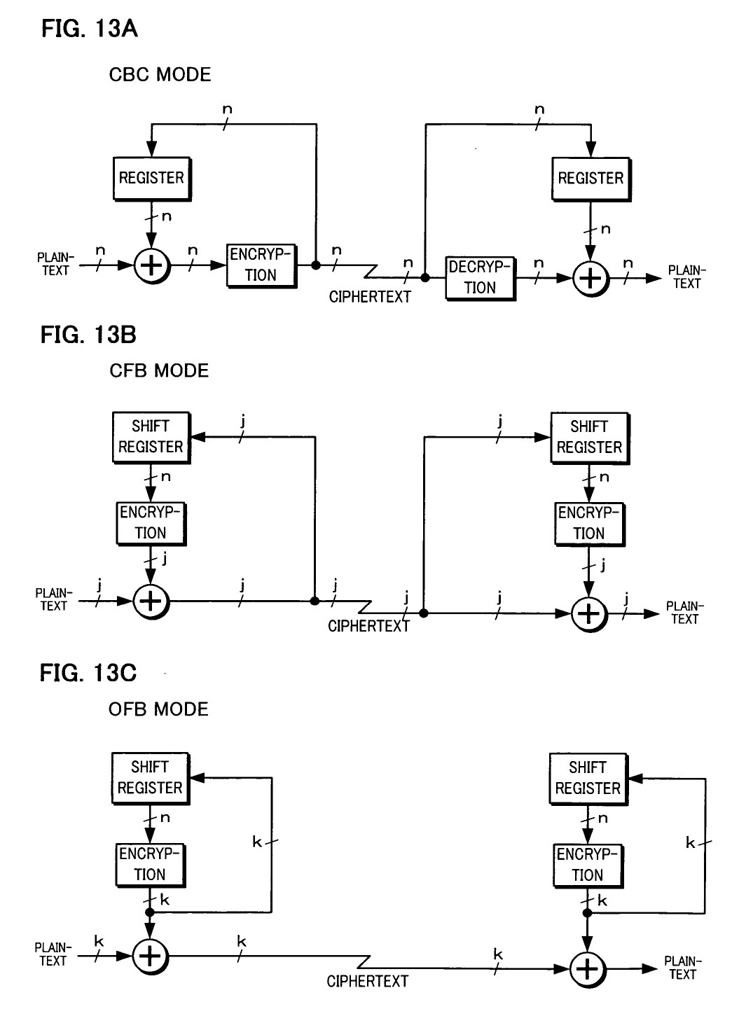

FIG. 13A is a diagram illustrative of the CBC mode.

When performing encryption processing in the CBC mode, the ciphertext in a block immediately before the block under processing is stored in a register. The exclusive OR is carried out in bit units between the plaintext in the block under processing and the ciphertext stored in the register, and the result is encrypted. In the first block of content data, the exclusive OR is carried out in bit units between the plaintext in the block under processing and the initial value IV instead of the ciphertext stored in the register.

When performing decryption processing in the CBC mode, the ciphertext input value in a block immediately before the block under processing is stored in the register. The exclusive OR is carried out in bit units between the decryption processing result in the block under processing and the ciphertext input value stored in the register to obtain plaintext. In the first block of content data, the exclusive OR is carried out in bit units between the plaintext in the block under processing and the initial value IV instead of the ciphertext stored in the register.

In the AES processing section 200 shown in FIG. 10, “n” in FIG. 13A may be set at “128”.

FIG. 13B is a diagram illustrative of the CFB mode.

When performing encryption processing in the CFB mode, the ciphertext in a block immediately before the block under processing is supplied to a shift register, and is shifted in the shift register. The latest n-bit data stored in the shift register is encrypted. The exclusive OR is carried out in bit units between j-bit (1≦j≦n, j is an integer) data of the n-bit data and the plaintext, and j-bit ciphertext is output. In the first block of content data, the initial value IV is encrypted instead of the data from the shift register, and the exclusive OR is carried out in bit units between the processing result and the plaintext in the block under processing.

When performing decryption processing in the CFB mode, the ciphertext in a block immediately before the block under processing is supplied to the shift register, and is shifted in the shift register. The latest n-bit data stored in the shift register is encrypted. The exclusive OR is carried out in bit units between j-bit data of the n-bit data and the ciphertext, and j-bit plaintext is output. In the first block of content data, the initial value IV is encrypted instead of the data from the shift register, and the exclusive OR is carried out in bit units between the processing result and the ciphertext in the block under processing.

FIG. 13C is a diagram illustrative of the OFB mode.

When performing encryption processing in the OFB mode, the encryption processing result in a block immediately before the block under processing is supplied to a shift register, and is shifted in the shift register. The latest n-bit data stored in the shift register is encrypted, and k bits (1≦k≦n, k is an integer) of the n-bit data are used as an encryption processing result. The exclusive OR is carried out in bit units between the encryption processing result and the plaintext, and k-bit ciphertext is output. In the first block of content data, the initial value IV is encrypted instead of the data from the shift register, and the exclusive OR is carried out in bit units between the processing result and the plaintext in the block under processing.

When performing decryption processing in the OFB mode, the encryption processing result in a block immediately before the block under processing is supplied to the shift register, and is shifted in the shift register. The latest n-bit data stored in the shift register is encrypted, and k bits of the n-bit data are used as the decryption processing result. The exclusive OR is carried out in bit units between the encryption processing result and the ciphertext, and k-bit plaintext is output. In the first block of content data, the initial value IV is encrypted instead of the data from the shift register, and the exclusive OR is carried out in bit units between the processing result and the ciphertext in the block under processing.

The operation mode of the block cipher method includes the ECB mode in addition to the CBC mode, the CFB mode, and the OFB mode. When performing encryption processing in the ECB mode, plaintext is directly encrypted. When performing decryption processing in the ECB mode, ciphertext is directly decrypted.

2.1.2 Storage of Intermediate Value

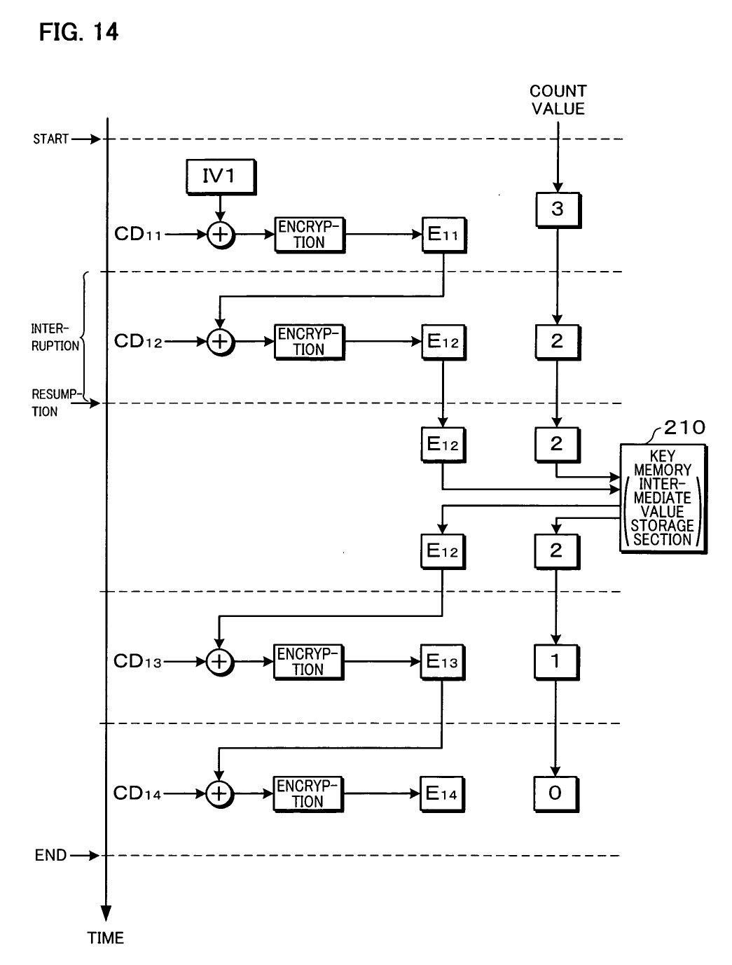

FIG. 14 is a diagram illustrative of the encryption operation using the key memory 210 in the CBC mode according to the first embodiment.

FIG. 14 shows the case where the first content data is divided into four pieces for convenience of description. In this case, the count value CNT is set at “3”.

When content data starts to be encrypted in the CBC mode, the exclusive OR is carried out in bit units between the divided data CD₁₁ of the first content data and the initial value IV1, and the result is encrypted to obtain encrypted data E₁₁.

In the next block, the count value CNT is decremented to “2”. The exclusive OR is carried out in bit units between the divided data CD₁₂ and the encrypted data E₁₁, and the result is encrypted to obtain encrypted data E₁₂.

In order to process content data having another identification information ID (e.g. second content data), the encrypted data E₁₂ necessary for encryption processing in the next block and the count value CNT are stored in the key memory 210 as the intermediate value storage section. Specifically, the encrypted data E₁₂ as the processing result and the count value CNT make up the intermediate value. In FIG. 14, the processing result and the count value CNT make up the intermediate value. However, a key (key in round units) necessary for encryption processing performed in block units and the initial value are also stored as the intermediate value.

When the processing of the first content data is resumed, the encrypted data E₁₂ and the count value CNT are read from the key memory 210.

In the next block, the count value CNT is decremented to “1”. The exclusive OR is carried out in bit units between the divided data CD₁₃ and the encrypted data E₁₂, and the result is encrypted to obtain encrypted data E₁₃.

In the next block, the count value CNT is decremented to “0”. The exclusive OR is carried out in bit units between the divided data CD₁₄ and the encrypted data E₁₃, and the result is encrypted to obtain encrypted data E₁₄.

Since the count value CNT is “0”, the encryption processing of the first content data ends.

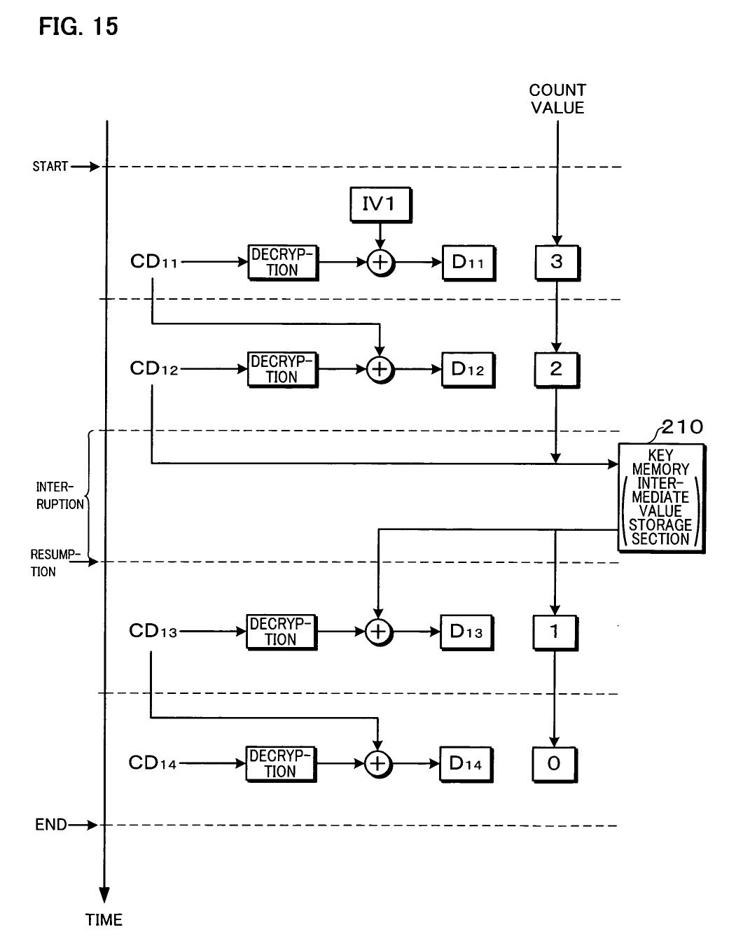

FIG. 15 is a diagram illustrative of the operation using the key memory 210 in the first embodiment during decryption in the CBC mode.

The divided data CD₁₁ of the first content data is decrypted, and the exclusive OR is carried out in bit units between the divided data CD₁₁ and the initial value IV1 to obtain decrypted data D₁₁.

In the next block, the count value CNT is decremented to “2”. The divided data CD₁₂ is then decrypted, and the exclusive OR is carried out in bit units between the divided data CD₁₂ and the previous input value data CD₁₁ to obtain decrypted data D₁₂.

In order to process content data having another identification information ID (e.g. second content data), the previous input value data CD₁₂ and the count value CNT are stored in the key memory 210 as the intermediate value storage section. Specifically, the encrypted data CD₁₂ as the input value and the count value CNT are stored as the intermediate values. In FIG. 15, the processing result and the count value CNT are stored as the intermediate values. However, a key (key in round units) necessary for decryption processing performed in block units and the initial value are also stored as the intermediate values.

When the processing of the first content data is resumed, the previous input value data CD₁₂ and the count value CNT are read from the key memory 210.

In the next block, the count value CNT is decremented to “1”. The divided data CD₁₃ is then decrypted, and the exclusive OR is carried out in bit units between the divided data CD₁₃ and the previous input value data CD₁₂ to obtain decrypted data D₁₃.

In the next block, the count value CNT is decremented to “0”. After performing similar decryption processing, since the count value CNT is “0”, the decryption processing of the first content data ends.

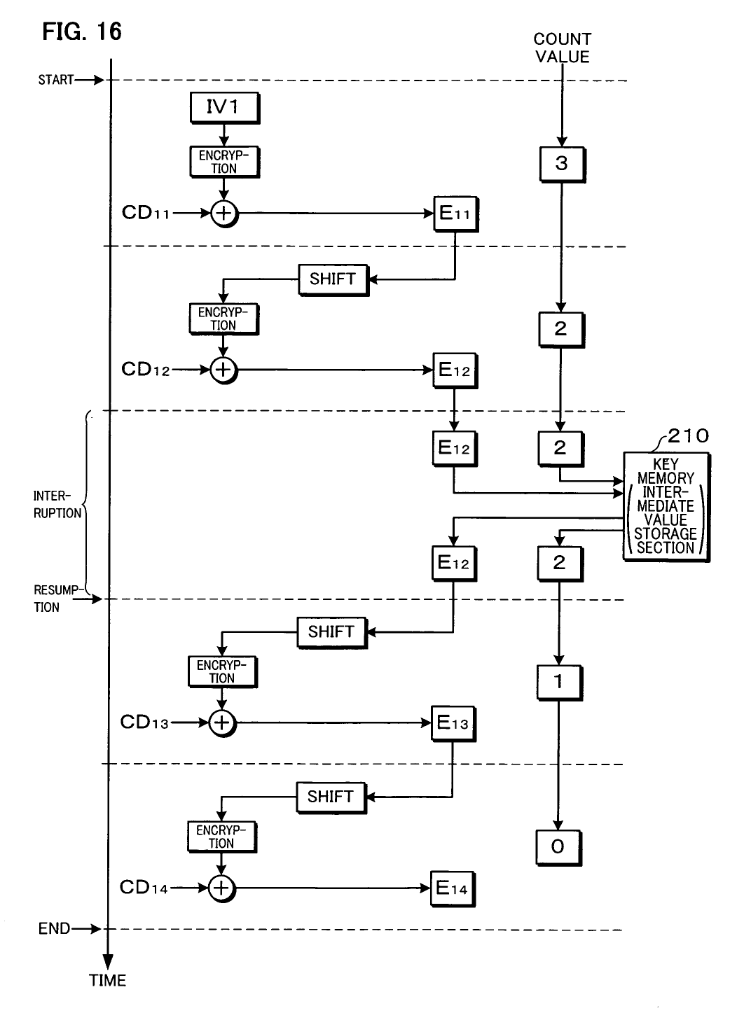

FIG. 16 is a diagram illustrative of the operation using the key memory 210 in the first embodiment in the CFB mode.

FIG. 16 shows the case where the first content data is divided into four pieces for convenience of description. In this case, the count value CNT is set at “3”.

When encryption processing of content data starts in the CBC mode, the initial value IV1 is encrypted, and the exclusive OR is carried out in bit units between the divided data CD₁₁ of the first content data and the encrypted data. As a result, exclusive-OR operation data E₁₁ is obtained.

In the next block, the count value CNT is decremented to “2”. Then, the exclusive-OR operation data E₁₁ is shifted. After a specific number of bits have been encrypted after the shift operation, the exclusive OR is carried out in bit units between the divided data CD₁₂ of the first content data and the encrypted data. As a result, exclusive-OR operation data E₁₂ is obtained.

In order to process content data having another identification information ID (e.g. second content data), the exclusive-OR operation data E₁₂ necessary for encryption processing in the next block and the count value CNT are stored in the key memory 210 as the intermediate value storage section. Specifically, the exclusive-OR operation data E₁₂ as the processing result and the count value CNT are stored as the intermediate values. In FIG. 16, the processing result and the count value CNT are stored as the intermediate values. However, a key (key in round units) necessary for encryption processing performed in block units and the initial value are also stored as the intermediate values.

When the processing of the first content data is resumed, the exclusive-OR operation data E₁₂ and the count value CNT are read from the key memory 210.

In the next block, the count value CNT is decremented to “1”. Then, the exclusive-OR operation data E₁₂ is shifted. After a specific number of bits have been encrypted after the shift operation, the exclusive OR is carried out in bit units between the divided data CD₁₃ of the first content data and the encrypted data. As a result, exclusive-OR operation data E₁₃ is obtained.

In the next block, the count value CNT is decremented to “0”. Then, the exclusive-OR operation data E₁₃ is shifted. After a specific number of bits have been encrypted after the shift operation, the exclusive OR is carried out in bit units between the divided data CD₁₄ of the first content data and the encrypted data. As a result, exclusive-OR operation data E₁₄ is obtained.

Since the count value CNT is “0”, the encryption processing of the first content data ends.

FIG. 16 illustrates the encryption processing in the CFB mode. Note that decryption processing in the CFB mode is performed in the same manner as described above.

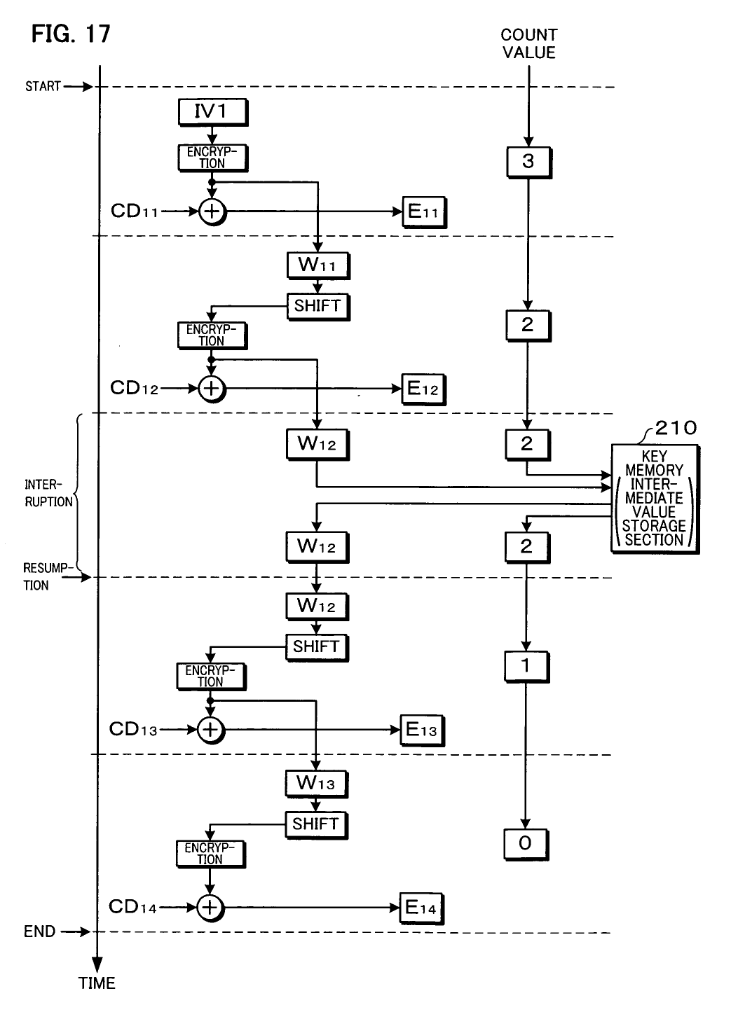

FIG. 17 is a diagram illustrative of the operation using the key memory 210 in the first embodiment in the OFB mode.

FIG. 17 shows the case where the first content data is divided into four pieces for convenience of description. In this case, the count value CNT is set at “3”.

When content data starts to be encrypted in the OFB mode, the initial value IV1 is encrypted, and the exclusive OR is carried out in bit units between the divided data CD₁₁ of the first content data and the encrypted data. As a result, exclusive-OR operation data E₁₁ is obtained.

In the next block, the count value CNT is decremented to “2”. Encrypted data W₁₁ obtained by encrypting the initial value IV1 is shifted, and a specific number of bits of shift data are encrypted after the shift operation. The exclusive OR is carried out in bit units between the encrypted data and the divided data CD₁₂ of the first content data. As a result, exclusive-OR operation data E₁₂ is obtained.

In order to process content data having another identification information ID (e.g. second content data), encrypted data W₁₂ necessary for encryption processing in the next block and the count value CNT are stored in the key memory 210 as the intermediate value storage section. The encrypted data W₁₂ is data obtained by encrypting a specific number of bits of encrypted data W₁₁ after the shift operation. Specifically, the encrypted data W₁₂ as the processing result and the count value CNT are stored as the intermediate values. In FIG. 17, the processing result and the count value CNT are stored as the intermediate values. However, a key (key in round units) necessary for encryption processing performed in block units and the initial value are also stored as the intermediate values.

When the processing of the first content data is resumed, the encrypted data W₁₂ and the count value CNT are read from the key memory 210.

In the next block, the count value CNT is decremented to “1”. Then, the encrypted data W₁₂ is shifted. After a specific number of bits have been encrypted after the shift operation, the exclusive OR is carried out in bit units between the encrypted data and the divided data CD₁₃ of the first content data. As a result, exclusive-OR operation data E₁₃ is obtained.

In the next block, the count value CNT is decremented to “0”. Then, the encrypted data W₁₃ is shifted. After a specific number of bits have been encrypted after the shift operation, the exclusive OR is carried out in bit units between the encrypted data and the divided data CD₁₄ of the first content data. As a result, exclusive-OR operation data E₁₄ is obtained.

Since the count value CNT is “0”, the encryption processing of the first content data ends.

FIG. 17 illustrates the encryption processing in the OFB mode. Note that decryption processing in the OFB mode is performed in the same manner as described above.

2.1.3 Header Information

The COM header is added to the above-described divided data. The COM header is added by the main CPU 40. The header analysis section 270 of the encryption/decryption device 100 performs the above-described control by analyzing the COM header. It becomes unnecessary to provide a control register or the like accessible by the main CPU 40 in order to designate the processing procedure of the encryption/decryption device 100 by providing the header analysis section 270, whereby the control and the configuration of the encryption/decryption device 100 can be simplified.

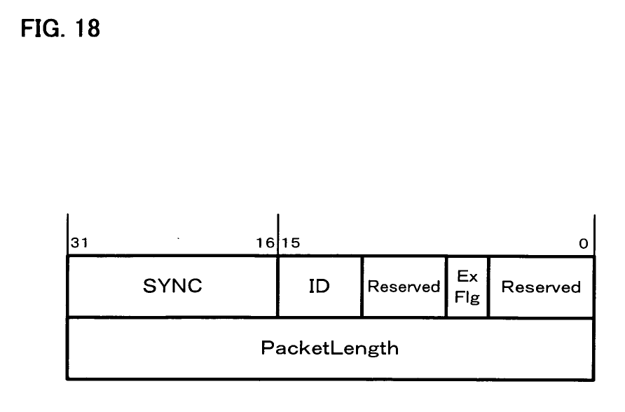

FIG. 18 shows a configuration example of the COM header according to the first embodiment.

The COM header includes a 16-bit length SYNC field, a 4-bit length TranTYPE field, a 1-bit length ExFlg field, and a 32-bit length PacketLength field.

A synchronization pattern for confirming that the header is the COM header is set in the SYNC field. A loss of synchronization with the main CPU 40 is detected by performing pattern matching of the synchronization pattern.

The identification information ID for determining the communication partner is set in the ID field. The encryption/decryption device 100 can change the key corresponding to content data in the AES processing section 200 by determining the identification information ID.

Information indicating addition of the PCPExtend field is set in the ExFlg field. The PCP end location can be specified by referring to this information so that the key update reference timing is obtained.

Information indicating the size of the packet to which the COM header is added is set in the PacketLength field. This information indicates the size of the data of the packet excluding the COM header.

In the first embodiment, the PCP header specified in “DTCP Volume 1 Supplement E Mapping DTCP to IP (Informational Version) (Revision 1.0, Nov. 24, 2003)” is extended to the PCPExtend header.

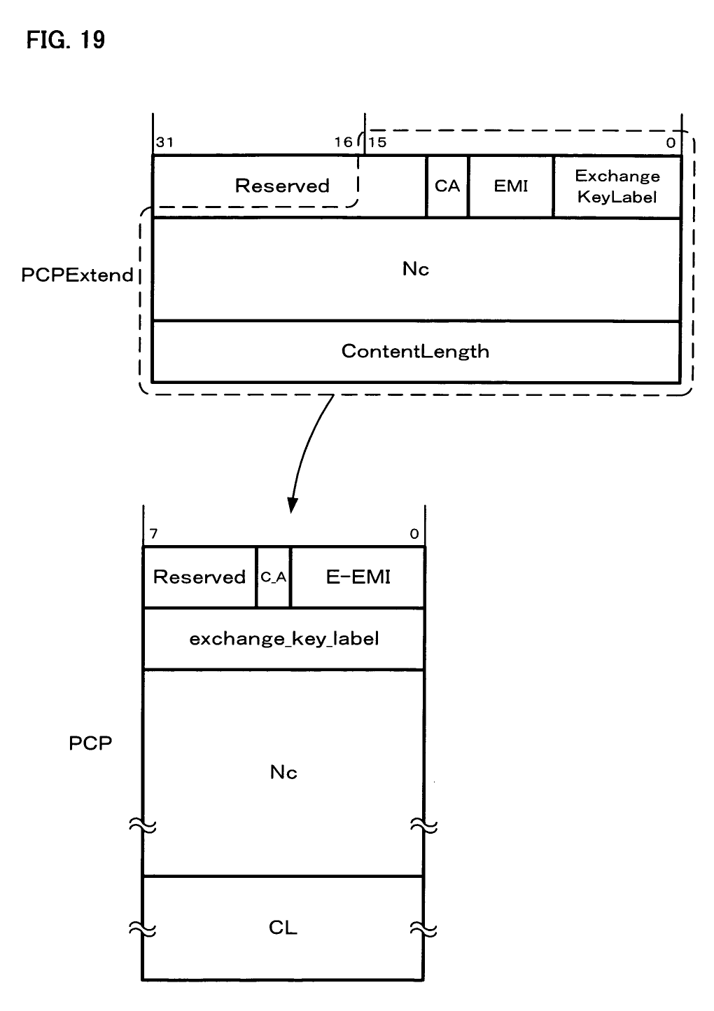

FIG. 19 is a diagram illustrative of the PCPExtend header and the PCP header.

Information set in a C_A field of the PCP header is set in a CA field. Information indicating AES using a 128-bit length block or an optional algorithm is set in the C_A field.

Information set in an E-EMI field of the PCP header is set in an EMI field. Copy control information such as Copy-never, Copy-one-generation, No-more-copies, or Copy-free is set in the E-EMI field.

Information set in an Exchange_key_label field of the PCP header is set in an ExchangeKeyLabel field. The exchange key Kx is set in an exchange_key_label field.

Information set in an Nc field of the PCP header is set in an Nc field. A random number used in the expressions (1) and (2) is set in the Nc field.

Information set in a CL field of the PCP header is set in a ContentLength field. The byte length of the content data is set in the CL field. Therefore, since the block cipher processing unit is known, the count value CNT can be calculated based on the information set in the ContentLength field, for example.

The PCPExtend header differs from the PCP header in that a Reserved field is expanded from three bits to 19 bits. This allows the length of a packet including the COM header and the PCPExtend header to be a multiple of 16 bytes (AES processing unit), so that the circuit configuration can be simplified.

2.1.4 Outline of Operation

An outline of the operation of the encryption/decryption device 100 shown in FIG. 10 is described below. Each section of the encryption/decryption device 100 is controlled by the state control section 250.

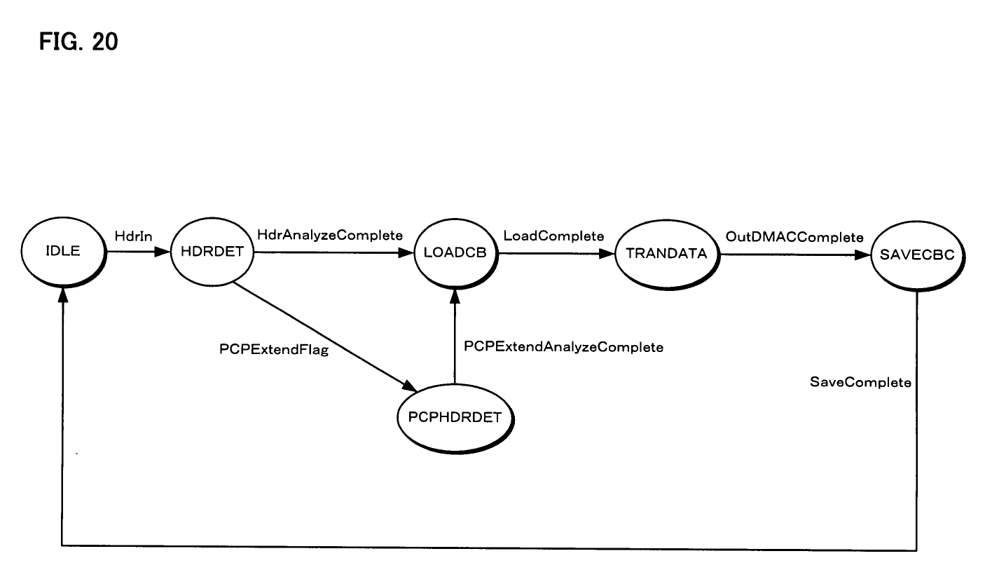

FIG. 20 is a diagram illustrative of the processing of the state control section 250 shown in FIG. 10.

The state control section 250 operates according to the state transition diagram shown in FIG. 20. Specifically, the state control section 250 transitions between each state, and outputs a control signal corresponding to the state after transition to each section of the encryption/decryption device 100.

An IDLE state is a state in which data is input to or output from the storage section 230 and data transfer or the like is not performed. In the IDLE state, when data starts to be set in the input area of the storage section 230 and it is determined that data corresponding to the data size of the COM header has been set based on the pointer managed by the pointer management section 240, HdrIn is set to active so that the state control section 250 transitions to an HDRDET state indicating that the COM header has been detected.

In the HDRDET state, the COM header is analyzed. Specifically, based on the information of the COM header shown in FIG. 18, content is distinguished corresponding to information set in the ID field, and the transfer data size is set in InDAMC and OutDMAC corresponding to the information set in the PacketLength field, for example. The CPU 280 sets the count value CNT in the AES processing section 200.

When it is determined in the HDRDET state that the PCPExtend header is added based on the information set in the ExFlg field of the COM header, the state control section 250 sets PCPExtendFlag to active and transitions to a PCPHDRDET state. When it is determined in the HDRDET state that the PCPExtend header is not added based on the information set in the ExFlg field of the COM header, the state control section 250 sets HdrAnalyzeComplete to active and transitions to a LOADCBC state.

The transition to the PCPHDRDET state is used as the reference timing of key update performed in PCP units. In FIG. 20, when the state control section 250 has detected that the PCPExtend header is added based on the information set in the ExFlg field, the state control section 250 issues an interrupt request to the CPU 280. The CPU 280 again generates the key to be updated, and sets the generated key in the key memory 210 through the internal bus. The AES processing section 200 performs encryption or decryption processing by using the key set in the key memory 210. When such a key update has been completed, in order to indicate completion of analysis of the PCPExtend header, the CPU 280 accesses a start control register (not shown) of the encryption/decryption device 100. PCPExtendAnalyzeComplete becomes active along with access to the start control register, and the state control section 250 transitions to the LOADCBC state.

In the LOADCBC state, the initial value IV and the key stored in the key memory 210 are read corresponding to the identification information ID when the count value CNT is “0”, and the intermediate value MV and the key stored in the key memory 210 are read corresponding to the identification information ID when the count value CNT is not “0”. In the LOADCBC state, when reading of data from the key memory 210 has been completed, LOADComplete becomes active so that the state control section 250 transitions to the TRANDATA state.

In the TRANDATA state, InDMAC reads data from the input area of the storage section 230 and transfers the data. The AES processing section 200 performs encryption or decryption processing, and OutDMAC stores the processing result data in the output area of the storage section 230. When the transfer of OutDMAC has been completed, OutDMACComplete becomes active so that the state control section 250 transitions to a SAVECBC state.

In the SAVECBC state, the intermediate value is saved. Specifically, the key memory control section 220 saves the processing result and the count value in the key memory 210.

When saving of the processing result and the count value in the key memory 210 has been completed, SaveComplete becomes active so that the state control section 250 transitions to the IDLE state.

As described above, in the first embodiment, the state control section 250 saves the intermediate value or the like in the key memory 210 each time encryption or decryption processing for the data size of the COM header is performed so that the control and the configuration are simplified. However, the intermediate value or the like may be saved only when a series of encryption or decryption processing of content data is interrupted.

2.2 Second Embodiment

The first embodiment illustrates the encryption/decryption device which performs processing according to one encryption algorithm. An encryption/decryption device according to a second embodiment can perform processing according to two encryption algorithms.

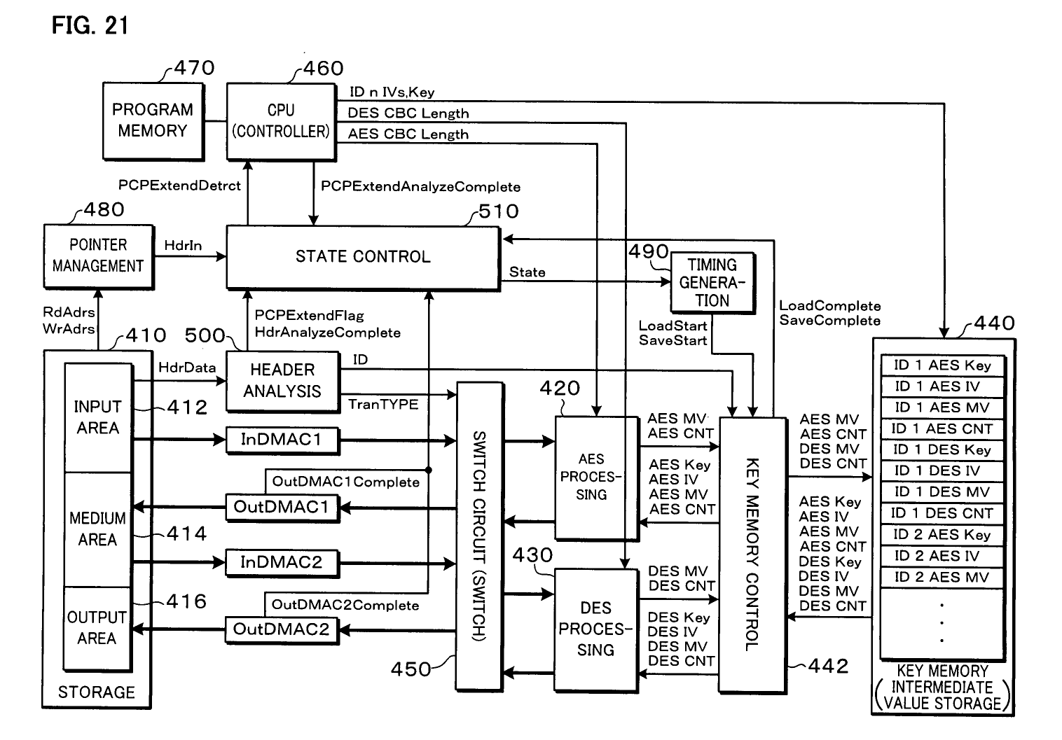

FIG. 21 is a block diagram of a configuration example of an encryption/decryption device according to the second embodiment.

The communication controller 50 of the electronic instrument 10 shown in FIG. 2 may include an encryption/decryption device 400 according to the second embodiment instead of the encryption/decryption device 100 according to the first embodiment.

The encryption/decryption device 400 can perform processing according to a plurality of encryption/decryption algorithms. In this configuration example, the encryption/decryption device 400 performs encryption or decryption processing according to the AES and DES algorithms for divided data of each of the first and second content data. In this configuration example, the encryption and decryption processing according to the DES algorithm is performed according to the method predetermined between the encryption/decryption device 400 and the main CPU 40.

The encryption/decryption device 400 includes a storage section 410, an AES processing section 420 (first encryption/decryption processing section in a broad sense), a DES processing section 430 (second encryption/decryption processing section in a broad sense), and a key memory 440 (intermediate value storage section in a broad sense). The storage section 410 stores divided data of content data as input data, and stores data obtained by subjecting the input data to encryption or decryption processing as output data.

The AES processing section 420 performs encryption or decryption processing according to the AES algorithm (first encryption processing or first decryption processing) for each divided data in the operation mode of the block cipher method using data in a block other than the block under processing, in the same manner as the AES processing section 200 shown in FIG. 10.

The DES processing section 430 performs encryption or decryption processing according to the DES algorithm (second encryption processing or second decryption processing) for each divided data in the operation mode of the block cipher method using data in a block other than the block under processing.

The key memory 440 stores the block-unit processing result of the AES processing section 420 and the block-unit processing result of the DES processing section 430 in content units, in the same manner as the key memory 210 shown in FIG. 10.

The storage section 230 stores decrypted data obtained by causing one of the AES processing section 420 and the DES processing section 430 (first and second encryption/decryption processing sections) to subject input data to encryption or decryption processing according to the AES algorithm or encryption or decryption processing according to the DES algorithm (first or second decryption processing). The storage section 230 stores data obtained by causing the other of the AES processing section 420 and the DES processing section 430 (first and second encryption/decryption processing sections) to subject the decrypted data to encryption processing as output data.

At least one of the AES processing section 420 and the DES processing section 430 encrypts or decrypts one of the divided data of the second content data as input data, and the processing result is stored in the key memory 440. At least one of the AES processing section 420 and the DES processing section 430 reads the processing result of the encryption/decryption processing section for the Kth divided data of the first content data from the key memory 440, and encrypts or decrypts the (K+1)th divided data of the first content data by using the processing result. In this case, the storage area of the storage section 410 for the decrypted data is configured to be inaccessible from the outside of the encryption/decryption device 400.

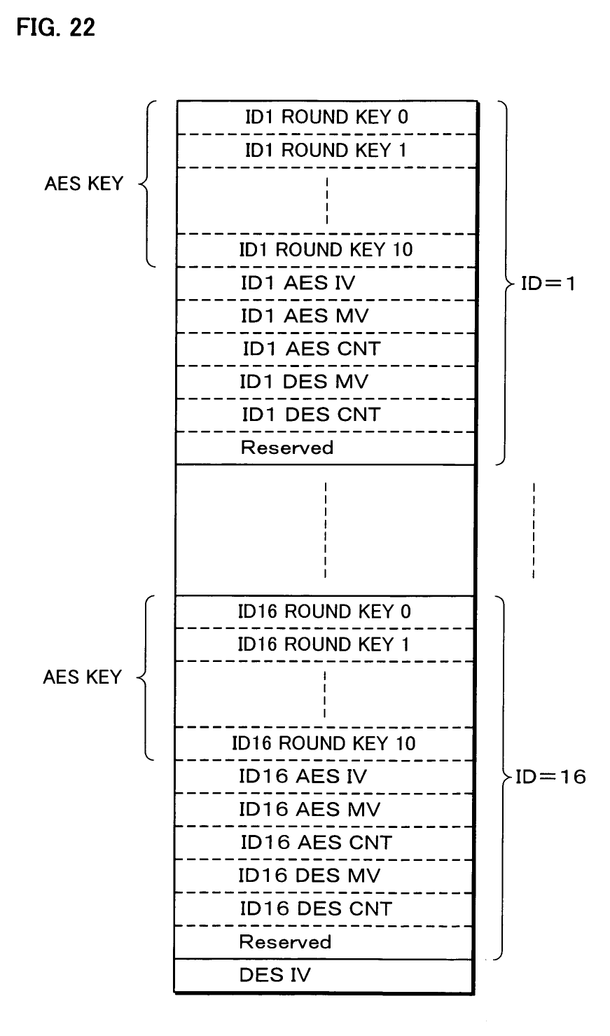

FIG. 22 shows an example of data stored in the key memory 440 shown in FIG. 21.

The key memory 440 stores information specific to content data in units of content distinguished by the identification information provided to the content data. The information specific to content data includes the AES key used for the AES processing section 420 to perform encryption or decryption processing, the initial value IV, the processing result (intermediate value) MV, and the count value CNT. The AES key in each round can be stored in the key memory 440. The initial value IV is an initial vector value used for the first block in the CBC mode of AES. The count value CNT is a value corresponding to the number of remaining blocks to be processed in the CBC mode of AES.

The information specific to content data also includes the processing result (intermediate value) MV and a count value CNT used in the DES processing section 430 to perform encryption or decryption processing. The count value CNT is a value corresponding to the number of remaining blocks to be processed in the CBC mode of DES.

Since it suffices that the key be shared between the DES processing section 430 and the main CPU 40, the initial value IV used in the DES processing section 430 is information common to each content.

The encryption/decryption device 400 includes a key memory control section 442 for accessing the key memory 440. The key memory control section 442 controls reading from the key memory 440 and writing into the key memory 440. The operation of the key memory control section 442 is the same as the operation of the key memory control section 220 shown in FIG. 10.

The encryption/decryption device 400 may include a switch circuit 450. The switch circuit 450 may switch the path for supplying input data to the AES processing section 420 or the DES processing section 430. The switch circuit 450 may switch the path for supplying data encrypted or decrypted by the AES processing section 420 to the output data storage area or the encrypted data storage area of the storage section 410. The switch circuit 450 may switch the path for supplying data encrypted or decrypted by the DES processing section 430 to the output data storage area or the decrypted data storage area of the storage section 410.

The encryption/decryption device 400 is controlled by a CPU 460 (controller) corresponding to the CPU 280 shown in FIG. 10. The CPU 460 may set the key used for encryption and decryption processing of the AES processing section 220 and set the key used for encryption and decryption processing of the DES processing section 430, for example. The CPU 460 controls the encryption/decryption device 400 according to a program stored in a program memory 470.

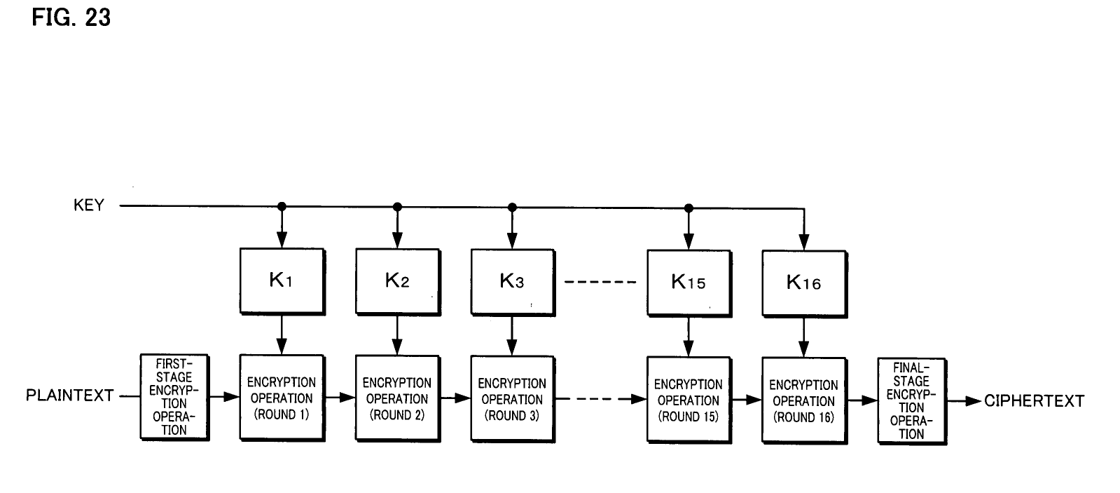

FIG. 23 shows the flow of processing performed by the DES processing section 430.

The encryption/decryption device 400 shares a common private key with the main CPU 40, and holds a key in round units based on the common private key. The DES processing section 430 performs an encryption operation in block units (one block has a length corresponding to 64-bit input data (plaintext)) while changing the key in round units.

In the first-stage encryption operation, an encryption operation such as initial transposition and bit division is performed. Encryption operations such as expansion transposition, exclusive-OR operation using the key in each round, compression substitution conversion, and transposition are performed from the round 1 to the round 16. In the final-stage encryption operation, bit replacement and final transposition are performed.

The decryption processing performed by the DES processing section 430 may be realized by performing each operation shown in FIG. 23 in the reverse order. In this case, the keys are used in the order of K₁₆, K₁₅, . . . , K₁, differing from the encryption processing.

Each operation of the DES processing section 430 is known in the art. Therefore, description of each operation is omitted.

Since the DES processing section 430 repeatedly performs the same operations, the processing speed can be increased by implementing the processing of the DES processing section 430 by hardware.

As described above, the encryption/decryption device 400 shown in FIG. 21 can perform encryption and decryption processing according to the AES and DES algorithms, and can change the encryption and decryption method for the input data and the output data. This allows data encrypted according to the AES or DES algorithm to be input to the encryption/decryption device 400 and output from the encryption/decryption device 400.

Therefore, even if the storage areas of the storage section 410 for the input data and the output data are accessible from the outside of the encryption/decryption device 400, unauthorized copying of the input data and the output data is prevented. Moreover, since the decrypted data is stored in the storage area of the storage section 410 inaccessible from the outside of the encryption/decryption device 400, unauthorized copying of the decrypted data is prevented.

In FIG. 21, first to third storage sections 412, 414, and 416 may be separately provided in the storage section 110 as an input area, a medium area, and an output area. The first storage section 412 as the input area is a storage section which is accessible from the outside of the encryption/decryption device 400 and stores input data. The second storage section 414 as the medium area is a storage section which is inaccessible from the outside of the encryption/decryption device 100 and stores decrypted data obtained by decrypting the input data according to the AES or DES algorithm. The third storage section 416 as the output area is a storage section which is accessible from the outside of the encryption/decryption device 100 and stores output data.

The encryption/decryption device 400 stores data obtained by causing one of the AES processing section 420 and the DES processing section 430 to perform decryption processing for input data in the second storage section 412, and stores data obtained by causing the other of the AES processing section 420 and the DES processing section 430 to perform encryption processing according to the AES or DES algorithm for the decrypted data in the third storage section 416 as output data.

The first to third storage sections 412, 414, and 416 may be provided in divided storage areas in one memory space as the input area (InputArea), the medium area (MediumArea), and the output area (OutputArea), respectively, and each storage area may be variable.

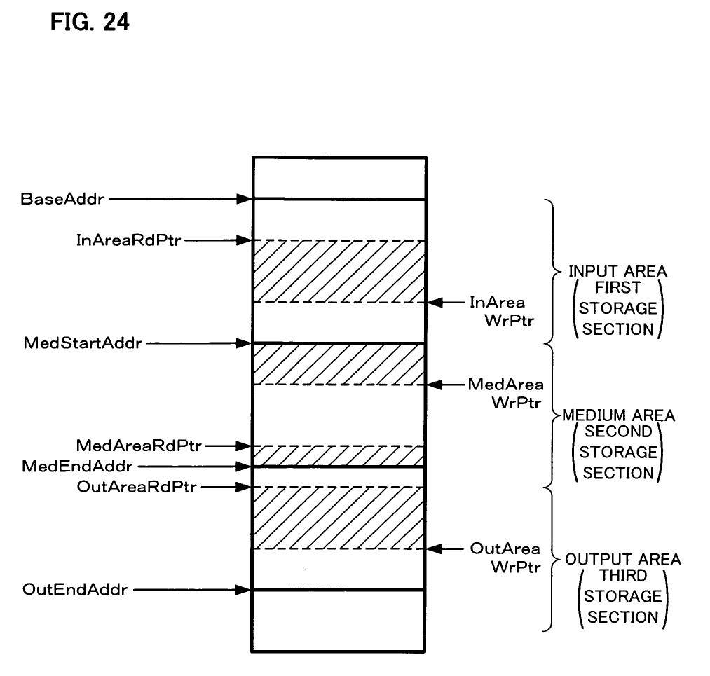

FIG. 24 shows a configuration example of the storage section 410 shown in FIG. 21, in which each storage area is set to be variable.

The input area, the medium area, and the output area of the storage section 410 are specified based on a base address BaseAddr. The encryption/decryption device 400 includes a storage area setting register as a control register (not shown), and the main CPU 40 changes the content set in the storage area setting register.

The storage area setting register may include a medium area start location setting register, a medium area end location setting register, and an output area end location setting register. A medium area start address MedStartAddr is set in the medium area start location setting register. A medium area end address MedEndAddr is set in the medium area end location setting register. An output area end address OutEndAddr is set in the output area end location setting register. As a result, the storage area of the storage section 410 from the address BaseAddr to the address (MedStartAddr−1) is set as the input area. The storage area of the storage section 410 from the address MedStartAddr to the address MedEndAddr is set as the medium area. The storage area of the storage section 410 from the address (MedEndAddr+1) to the address OutEndAddr (or (OutEndAddr−1)) is set as the output area.

It is preferable that the main CPU change the content set in each of the medium area start location setting register, the medium area end location setting register, and the output area end location setting register based on the content data division unit. If the base address BaseAddr can be changed, the input area, the medium area, and the output area can be set at arbitrary locations of the storage section 410.

In the encryption/decryption device 400, the input area, the medium area, and the output area are accessed as ring buffers. Each area is managed by using a read pointer (InAreaRdPtr, MedAreaRdPtr, OutAreaRdPtr) which designates the data read location and a write pointer (InAreaWrPtr, MedAreaWrPtr, OutAreaWrPtr) which designates the data write location. When the pointer has reached the end address of each area, the pointer is set at the start address of the area when the pointer is updated.

A pointer management section 480 shown in FIG. 21 corresponds to the pointer management section 240 shown in FIG. 10. The pointer management section 480 manages and updates the write pointer and the read pointer of each area of the storage section 410. A timing generation section 490 shown in FIG. 21 corresponds to the timing generation section 260 shown in FIG. 10. A header analysis section 500 shown in FIG. 21 corresponds to the header analysis section 270 shown in FIG. 10. A state control section 510 shown in FIG. 21 corresponds to the state control section 250 shown in FIG. 10.

In FIG. 21, INDMAC1 reads data from the input area and outputs the data to the switch circuit 450. OutDMAC1 outputs the data from the switch circuit 450 to the medium area. InDAMC2 reads data from the medium area and outputs the data to the switch circuit 450. OutDMAC2 outputs the data from the switch circuit 450 to the output area.

2.2.1 Outline of Operation

An outline of the operation of the encryption/decryption device 400 shown in FIG. 21 is described below. Each section of the encryption/decryption device 400 is controlled by the state control section 510.

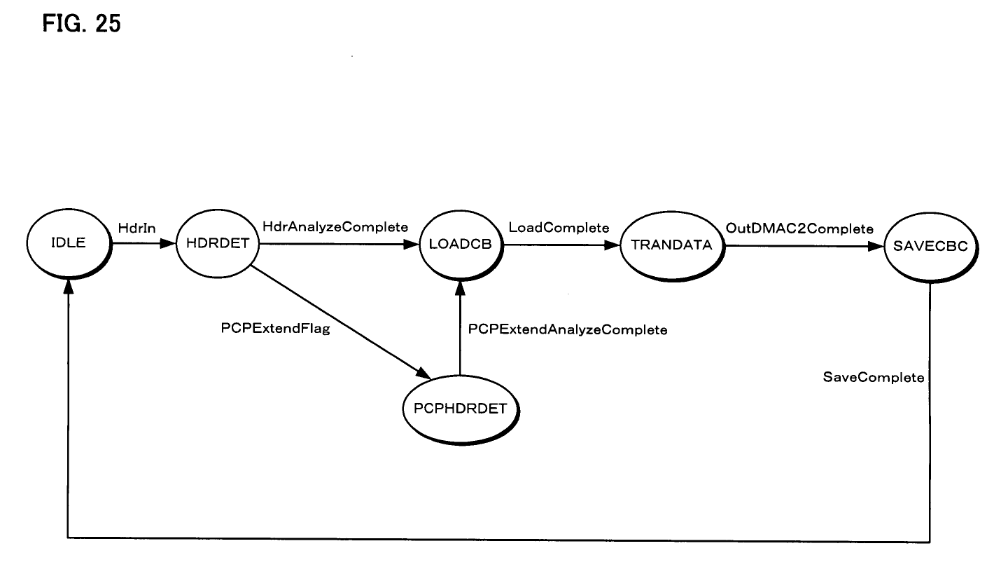

FIG. 25 is a diagram illustrative of processing of the state control section 510 shown in FIG. 21.

The major difference between FIG. 20 and FIG. 25 is that, in the TRANDATA state, the processing result of one of the AES processing section 420 and the DES processing section 430 is stored in the medium area based on the analysis result of the header analysis section 500, the processing result is read and processed by the other of the AES processing section 420 and the DES processing section 430, and the processing result is stored in the output area. Moreover, transition from the TRANDATA state to the SAVECBC state occurs on condition that OutDMAC2Complete indicating that data transfer of OutDMAC2 has been completed has become active.

In the SAVECBC state, data as described with reference to FIG. 22 is stored as the intermediate value.

In the second embodiment, the encryption/decryption device can be controlled based on the information set in the COM header in the same manner as in the first embodiment, and control using the AES processing section 420, the DES processing section 430, and the switch circuit 450 can be performed.

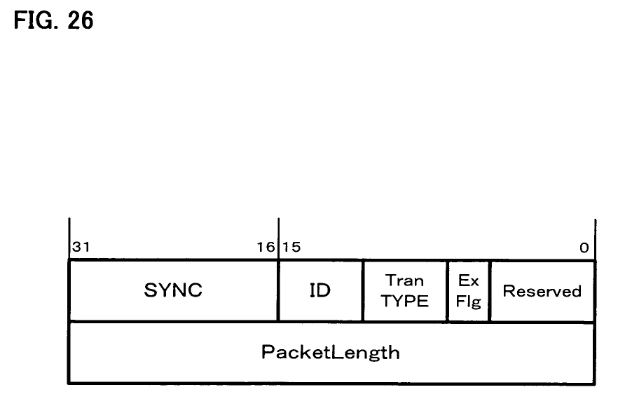

FIG. 26 shows a configuration example of the COM header according to the second embodiment.

The COM header according to the second embodiment differs from the COM header according to the first embodiment shown in FIG. 18 in that the COM header according to the second embodiment includes a 4-bit length TranTYPE field.

Information designating the type of encryption and decryption processing performed by the AES processing section 420 and the DES processing section 430 is set in the TranTYPE field. The operation mode can be changed by setting this information so that the order of encryption and decryption processing of content data can be changed as shown in FIG. 5 or 6, for example.

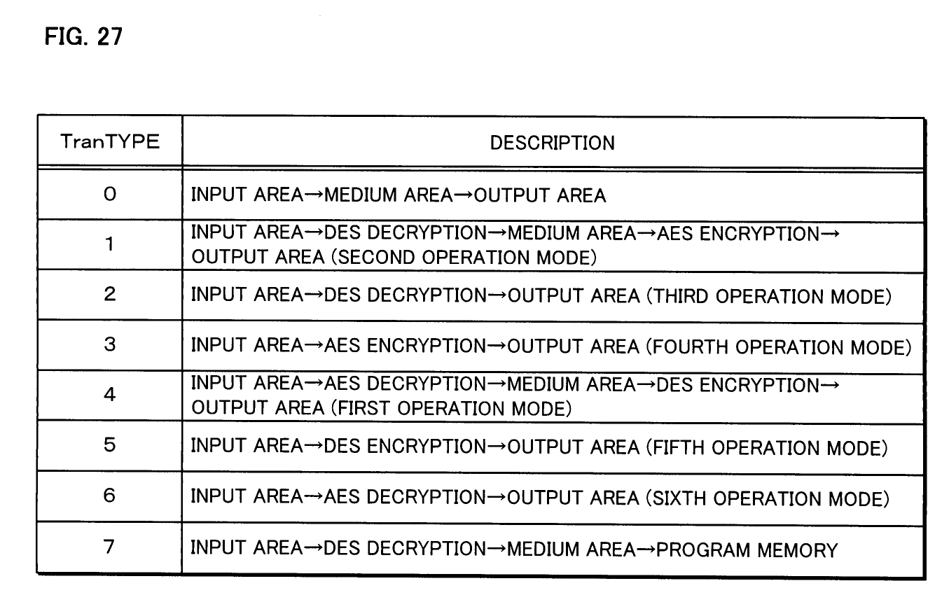

FIG. 27 is a diagram illustrative of the TranTYPE field shown in FIG. 26.

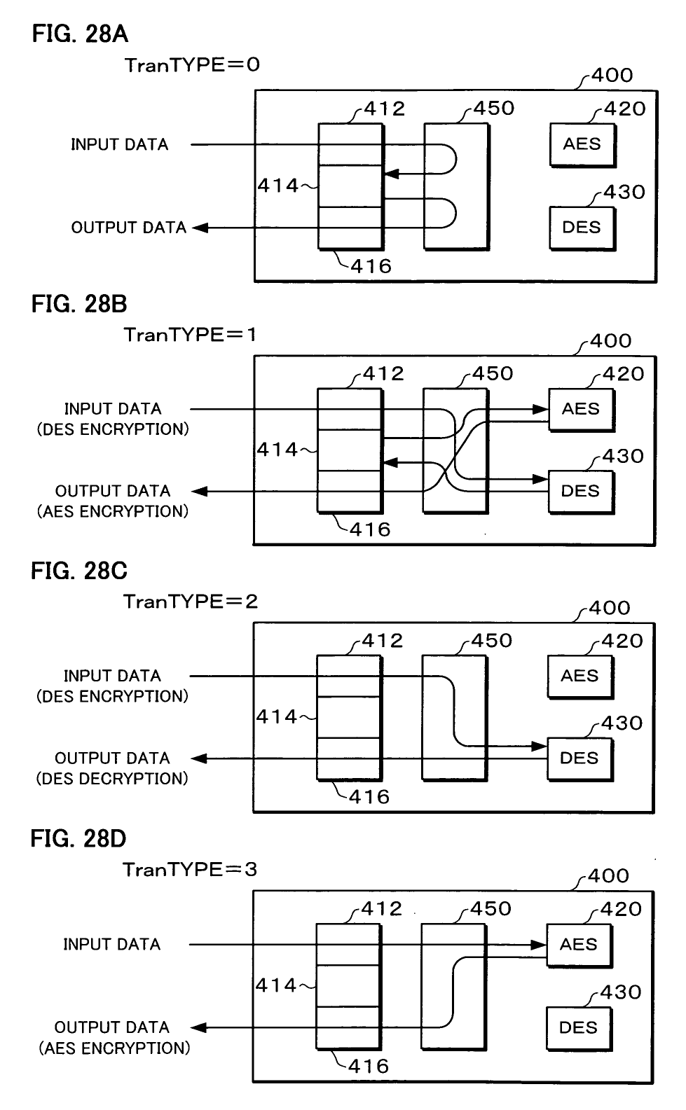

FIGS. 28A to 28D, 29A to 29C, and 30 are diagrams illustrative of the operation mode corresponding to the information set in the TranTYPE field. In FIGS. 28A to 28D, 29A to 29C, and 30, sections the same as the sections shown in FIG. 21 are indicated by the same symbols. Description of these sections is appropriately omitted.

The encryption/decryption device 400 operates in the operation mode corresponding to the information set in the TranTYPE field.

When “0h” (h indicates hexadecimal representation) is set in the TranTYPE field, the encryption/decryption device 400 operates in a debug mode. Specifically, as shown in FIG. 28A, content data (input data) written by the main CPU 40 is read from the input area (first storage section) and supplied to the switch circuit 450. The switch circuit 450 directly outputs the content data to the medium area (second storage section) so that the content data is stored in the medium area. After the content data has been read from the medium area and supplied to the switch circuit 450, the switch circuit 450 directly outputs the content data to the output area (third storage section) so that the content data is stored in the output area. This allows the output data read by the main CPU to be the same as the input data.

When “1h” is set in the TranTYPE field, the encryption/decryption device 400 operates in a second operation mode. Specifically, as shown in FIG. 28B, the main CPU stores content data encrypted according to DES in the input area (first storage section) as input data. The content data (input data) is read from the input area (first storage section) and supplied to the switch circuit 450. The switch circuit 450 supplies the content data to the DES processing section 430. The DES processing section 430 decrypts the content data according to the DES algorithm, and supplies the decrypted data to the switch circuit 450 as decrypted data. The switch circuit 450 outputs the decrypted data to the medium area (second storage section) so that the decrypted data is stored in the medium area. After the decrypted data has been read from the medium area and supplied to the switch circuit 450, the switch circuit 450 supplies the decrypted data to the AES processing section 420. The AES processing section 420 encrypts the decrypted data according to the AES algorithm, and supplies the encrypted data to the switch circuit 450 as output data. The switch circuit 450 outputs the output data to the output area (third storage section) so that the output data is stored in the output area. As a result, while the input data stored by the main CPU is data after encryption processing according to DES, the output data read by the main CPU is data after encryption processing according to AES. For example, when the communication controller 50 transmits content data, the encryption/decryption device 400 is set in the second operation mode.

When “2h” is set in the TranTYPE field, the encryption/decryption device 400 operates in a third operation mode. Specifically, as shown in FIG. 28C, the main CPU stores content data encrypted according to DES in the input area (first storage section) as input data. The content data (input data) is read from the input area (first storage section) and supplied to the switch circuit 450. The switch circuit 450 supplies the content data to the DES processing section 430. The DES processing section 430 decrypts the content data according to the DES algorithm, and supplies the decrypted content data to the switch circuit 450 as decrypted data. The switch circuit 450 outputs the decrypted data to the output area (third storage section) as output data so that the output data is stored in the output area. As a result, while the input data stored by the main CPU is data before decryption processing according to DES, the output data read by the main CPU is data after decryption processing according to DES. For example, when using the encryption/decryption device 400 as a DES decoder, the encryption/decryption device 400 is set in the third operation mode.

When “3h” is set in the TranTYPE field, the encryption/decryption device 400 operates in a fourth operation mode. Specifically, as shown in FIG. 28D, content data (input data) stored by the main CPU 40 is read from the input area (first storage section) and supplied to the switch circuit 450. The switch circuit 450 supplies the content data to the AES processing section 420. The AES processing section 420 encrypts the content data according to the AES algorithm, and supplies the encrypted data to the switch circuit 450. The switch circuit 450 outputs the encrypted data to the output area (third storage section) as output data so that the output data is stored in the output area. As a result, while the input data stored by the main CPU is data before encryption processing according to AES, the output data read by the main CPU is data after encryption processing according to AES. For example, when using the encryption/decryption device 400 as an AES encoder, the encryption/decryption device 400 is set in the fourth operation mode.

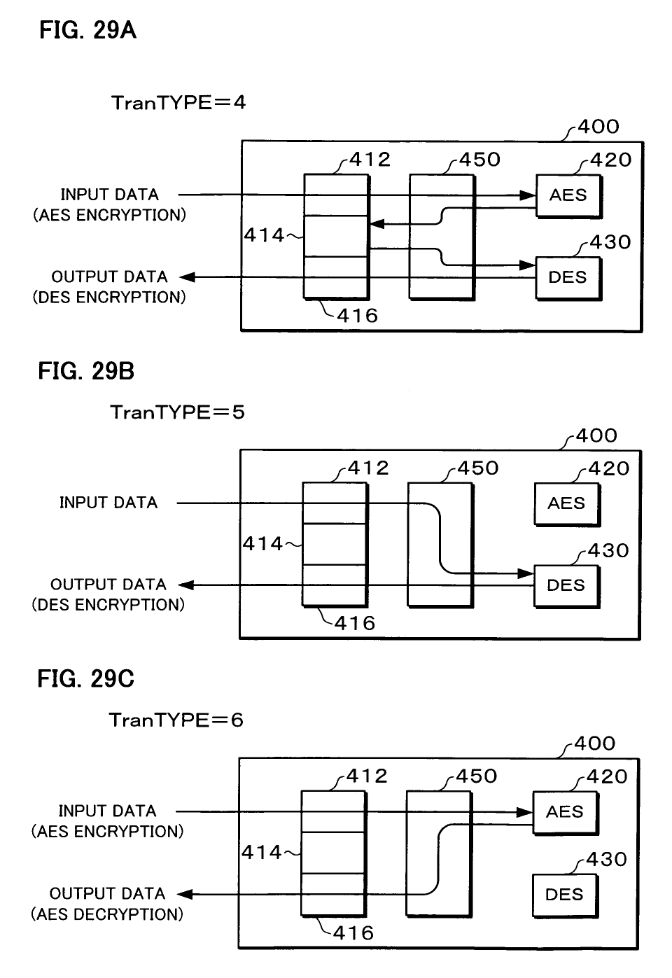

When “4h” is set in the TranTYPE field, the encryption/decryption device 400 operates in a first operation mode. Specifically, as shown in FIG. 29A, the main CPU stores content data encrypted according to AES in the input area (first storage section) as input data. The content data (input data) is read from the input area (first storage section) and supplied to the switch circuit 450. The switch circuit 450 supplies the content data to the AES processing section 420. The AES processing section 420 decrypts the content data according to the AES algorithm, and supplies the decrypted content data to the switch circuit 450 as decrypted data. The switch circuit 450 outputs the decrypted data to the medium area (second storage section) so that the decrypted data is stored in the medium area. After the decrypted data has been read from the medium area and supplied to the switch circuit 450, the switch circuit 450 supplies the decrypted data to the DES processing section 430. The DES processing section 430 encrypts the decrypted data according to the DES algorithm, and supplies the encrypted data to the switch circuit 450 as output data. The switch circuit 450 outputs the output data to the output area (third storage section) so that the output data is stored in the output area. As a result, while the input data stored by the main CPU is data after encryption processing according to AES, the output data read by the main CPU is data after encryption processing according to DES. For example, when the communication controller 50 receives content data, the encryption/decryption device 400 is set in the first operation mode.

When “5h” is set in the TranTYPE field, the encryption/decryption device 400 operates in a fifth operation mode. Specifically, as shown in FIG. 29B, content data (input data) stored by the main CPU 40 is read from the input area (first storage section) and supplied to the switch circuit 450. The switch circuit 450 supplies the content data to the DES processing section 430. The DES processing section 430 encrypts the content data according to the DES algorithm, and supplies the encrypted data to the switch circuit 450 as output data. The switch circuit 450 outputs the output data to the output area (third storage section) so that the output data is stored in the output area. As a result, while the input data stored by the main CPU is data before encryption processing according to DES, the output data read by the main CPU is data after encryption processing according to DES. For example, when using the encryption/decryption device 400 as a DES encoder, the encryption/decryption device 400 is set in the fifth operation mode.

When “6h” is set in the TranTYPE field, the encryption/decryption device 400 operates in a sixth operation mode. Specifically, as shown in FIG. 29C, the main CPU stores content data encrypted according to AES in the input area (first storage section) as input data. The content data (input data) is read from the input area (first storage section) and supplied to the switch circuit 450. The switch circuit 450 supplies the content data to the AES processing section 420. The AES processing section 420 decrypts the content data according to the AES algorithm, and supplies the decrypted content data to the switch circuit 450 as decrypted data. The switch circuit 450 outputs the decrypted data to the output area (third storage section) as output data so that the output data is stored in the output area. As a result, while the input data stored by the main CPU is data before decryption processing according to AES, the output data read by the main CPU is data after decryption processing according to AES. For example, when using the encryption/decryption device 400 as an AES decoder, the encryption/decryption device 400 is set in the sixth operation mode.

As described above, in the first and second operation modes, the main CPU and the encryption/decryption device 400 can transmit and receive encrypted content data, and the encryption/decryption device 400 can function as an AES or DES encoder or decoder.

In the second embodiment, the encryption/decryption device 400 may operate in a program decryption mode as described below.

Specifically, when “7h” is set in the TranTYPE field, the encryption/decryption device 400 operates in the program decryption mode. In the program decryption mode, when encrypted program data which designates the operation of the CPU 460 is supplied from the main CPU, the encryption/decryption device 400 decrypts the program data and transfers the decrypted program data to the program memory 470.

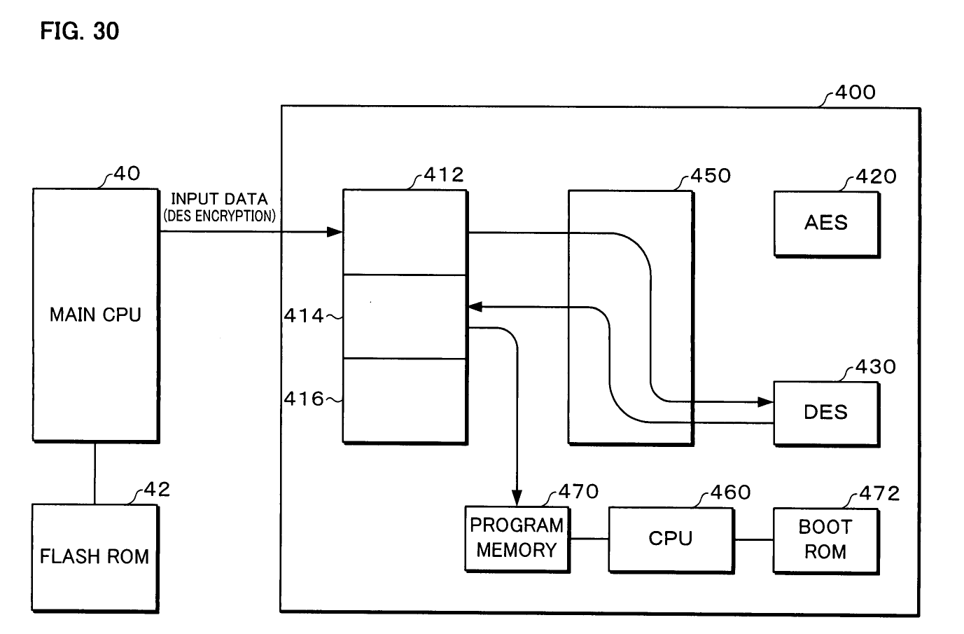

Therefore, as shown in FIG. 30, it is preferable that a flash read only memory (ROM) 42 which stores program data encrypted according to the DES algorithm be connected with the main CPU 40, and a boot ROM 472 which stores a boot program code be connected with the CPU 460. The program data stored in the flash ROM 42 is program data including data for generating an encryption key for performing AES and DES encryption processing and a decryption key for performing AES and DES decryption processing, and designating the operation of the CPU 460. Therefore, after the decrypted data has been transferred to the program memory 470 as the program data, the CPU 460 can control the operation of the encryption/decryption device 400 based on the program data.

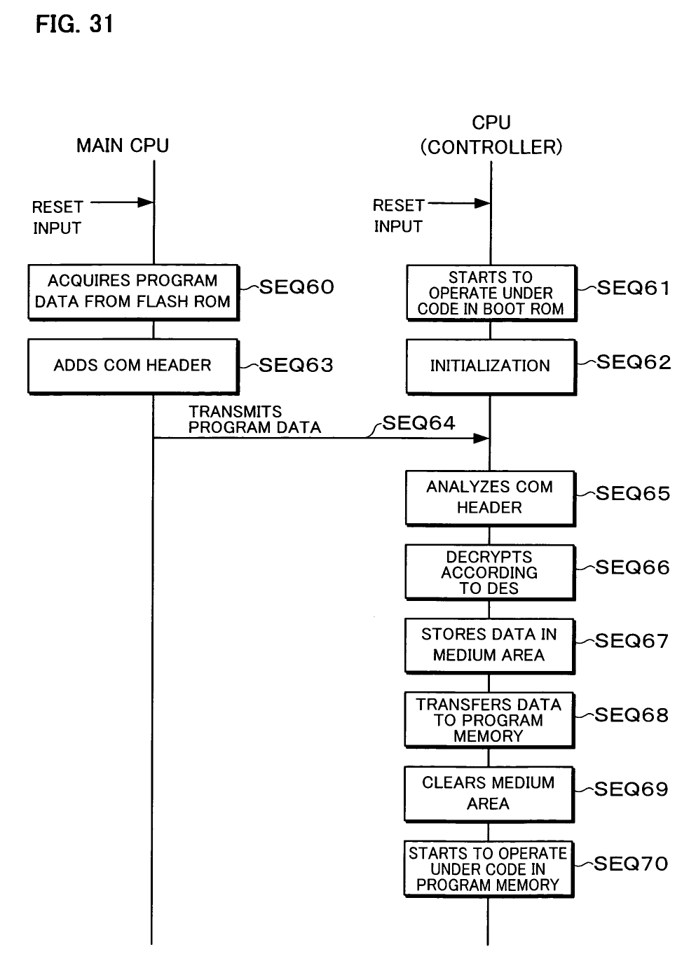

FIG. 31 shows a sequence in the program decryption mode.

When a reset signal is input so that the main CPU 40 is initialized, the main CPU 40 acquires encrypted program data from the flash ROM 42 (SEQ60). The CPU 460 is also initialized and starts to operate under the boot program code stored in the boot ROM 472 (SEQ61), and initializes each section of the encryption/decryption device 400 (SEQ62). A DES decryption key is set in advance in the boot program code.

The main CPU 40 adds the COM header in which “7h” is set in the TranTYPE field to the program data (SEQ63), and sets the program data in the input area (SEQ64).

The encryption/decryption device 400 analyzes the COM header (SEQ65). When the encryption/decryption device 400 has determined that “7h” is set in the TranTYPE field so that the program decryption mode is designated, the encryption/decryption device 400 reads the encrypted program data from the input area and supplies the program data to the switch circuit 450. The switch circuit 450 outputs the program data to the DES processing section 430. The DES processing section 430 decrypts the program data according to the DES algorithm (SEQ66), and supplies the decrypted program data to the switch circuit 450 as decrypted data. The switch circuit 450 outputs the decrypted data to the medium area, and the decrypted data is stored in the medium area (SEQ67).

The decrypted data stored in the medium area is transferred to the program memory 470 (SEQ68), and the medium area is cleared (SEQ69). Then, the CPU 460 starts to operate under the program data stored in the program memory 470 (SEQ70).

Since the program data stored in the program memory 470 includes the procedure and data for generating the AES key as described above, the program data must be encrypted when supplied from the main CPU 40 to the encryption/decryption device 400. Therefore, the second storage section 414 as the medium area can be effectively utilized while maintaining the security of the procedure and data for generating the AES key by using the program decryption mode.

The second embodiment illustrates the encryption/decryption device which can process two encryption algorithms. However, the encryption/decryption device may process three or more encryption algorithms.

By applying the encryption/decryption device 400 according to the second embodiment, the communication controller 50 shown in FIG. 2 may include a communication processing section which performs transmission processing and reception processing of communication data, and one of the above-described encryption/decryption devices. When the communication controller 50 receives communication data, as shown in FIG. 5, the encryption/decryption device 400 performs decryption processing according to AES (first decryption processing) for input data, which is data after encryption processing according to AES (after first encryption processing) in a layer higher than the layer of the header information analyzed by the TCP/IP processing section 60 (communication processing section), performs encryption processing according to DES for the decrypted data, and outputs the encrypted data (data after second encryption processing) as output data. When the communication controller 50 transmits communication data, as shown in FIG. 6, the encryption/decryption device 400 performs decryption processing according to DES (second decryption processing) for transmission data as input data, performs encryption processing according to AES (first decryption processing) for the decrypted data, and outputs the encrypted data as output data, and the TCP/IP processing section 60 adds the higher-layer header information to the output data, and transmits the resulting data to the network.

The electronic instrument 10 may include the communication controller 50, and the main CPU as a processing section which generates divided data of content data and performs encryption and decryption processing according to DES. When the electronic instrument 10 receives communication data, the communication controller 50 supplies data after encryption processing according to DES to the main CPU. When the electronic instrument 10 transmits communication data, the main CPU 40 supplies data after encryption processing according to DES to the communication controller 50 as input data.

3. Modification

In the second embodiment, it suffices that the encryption algorithm be predetermined between the main CPU 40 and the encryption/decryption device 400. Therefore, in order to correctly process content data, it is necessary to correctly save the processing result such as the intermediate value in the block cipher method such as the CBC mode of AES. On the other hand, if it is predetermined between the main CPU 40 and the encryption/decryption device 400 that the processing result is not used, it is unnecessary to correctly perform the operation mode of the block cipher method such as the CBC mode of DES.

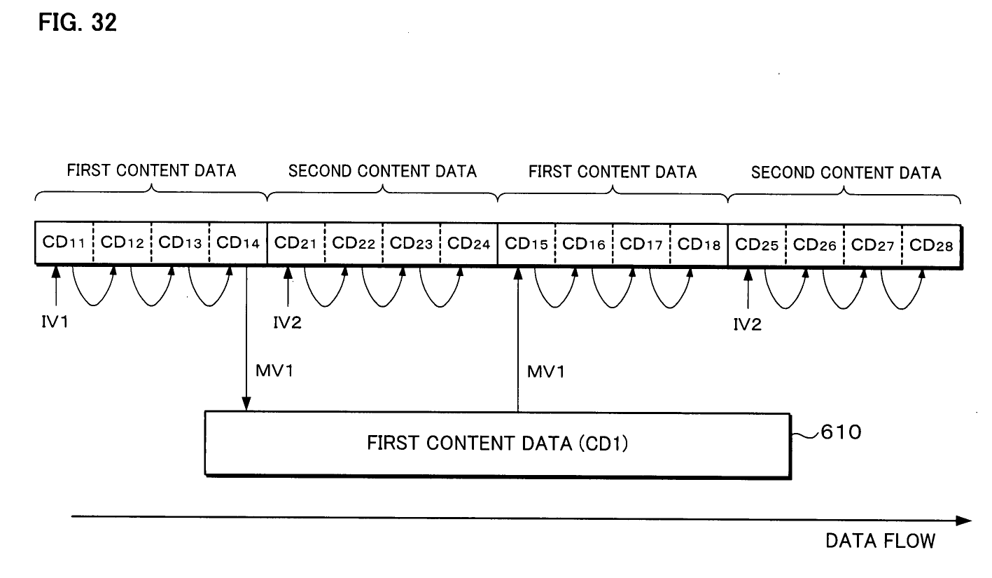

FIG. 32 is a diagram illustrative of the first and second content data encrypted or decrypted in the CBC mode of AES and DES in this modification.

In FIG. 32, the first content data is encrypted or decrypted according to AES, and the second content data is encrypted or decrypted according to DES.

In this modification, the encryption/decryption device 400 sequentially encrypts or decrypts the divided data CD₁₁ to CD₁₈ of the first content data in the order from the divided data CD₁₁. After the encryption/decryption device 400 has encrypted or decrypted the divided data CD₁₄, the encryption/decryption device 400 stores the processing result or input value MV1 in an intermediate value storage section 610. This is because the first content data is data processed by using the method specified in the DTCP standard.

The encryption/decryption device 400 then starts encrypting or decrypting the second content data CD2. The encryption/decryption device 400 reads the initial value IV2, and sequentially encrypts or decrypts the divided data CD₂₁ to CD₂₈ of the second content data in the order from the divided data CD₂₁. In this case, the encryption/decryption device 400 does not store the processing result or input value MV2, which is the result of encryption or decryption processing for the divided data CD₂₄, in the intermediate value storage section 610.

Then, the encryption/decryption device 400 starts encrypting or decrypting the first content data CD1. In this case, the encryption/decryption device 400 reads the processing result or input value MV1 from the intermediate value storage section 610, and encrypts or decrypts the divided data CD₁₅ by using the processing result or input value MV1. The encryption/decryption device 400 sequentially encrypts or decrypts the divided data CD₁₆ to CD₁₈.

Then, the encryption/decryption device 400 starts encrypting or decrypting the second content data CD2. In this case, the encryption/decryption device 400 does not read the processing result from the intermediate value storage section 610, and sequentially encrypts or decrypts the divided data CD₂₁ to CD₂8 of the second content data in the order from the divided data CD₂₁ by again using the initial value IV2. The encryption/decryption device 400 then sequentially encrypts or decrypts the divided data CD₂₂ to CD₂₈.

It suffices that the main CPU 40 use the initial value IV2 in encryption or decryption processing according to DES without reading the intermediate value each time the processing is resumed. As a result, the main CPU 40 and the encryption/decryption device can transmit and receive encrypted data. Therefore, the capacity of the intermediate value storage section 610 can be reduced, and the encryption or decryption processing can be simplified.

The invention is not limited to the above-described embodiments. Various modifications and variations may be made within the spirit and scope of the invention. For example, the block cipher method according to the invention is not limited to the above-described AES and DES. Other encryption and decryption algorithms such as M6 may also be used. The CBC mode, the CFB mode, and the OFB mode are described above as the operation modes of the block cipher method. However, the operation mode is not limited thereto. The invention may also be applied to an operation mode developed from or developed by improving the CBC mode, the CFB mode, or the OFB mode.

The encryption/decryption device does not necessarily include all the blocks shown in FIGS. 2, 10, and 21. The encryption/decryption device may have a configuration in which some of the blocks shown in FIGS. 2, 10, and 21 are omitted.

Part of requirements of any claim of the invention could be omitted from a dependent claim which depends on that claim. Moreover, part of requirements of any independent claim of the invention could be made to depend on any other independent claim.

Although only some embodiments of the invention have been described in detail above, those skilled in the art will readily appreciate that many modifications are possible in the embodiments without departing from the novel teachings and advantages of this invention. Accordingly, all such modifications are intended to be included within the scope of this invention.

What is claimed is:

1. An encryption/decryption device which performs encryption or decryption processing for divided data of first and second content data, the encryption/decryption device comprising:
an encryption/decryption processing section which performs encryption or decryption processing for the divided data in an operation mode of a block cipher method using data in a block other than a block under processing; and
an intermediate value storage section which stores a block-unit processing result or an input value of the encryption/decryption processing section in content units,
wherein, after the processing result or the input value of the encryption or decryption processing performed by the encryption/decryption processing section for one of the divided data of the second content data has been stored in the intermediate value storage section, the processing result or the input value for the Kth (K is a natural number) divided data of the first content data is read from the intermediate value storage section, and the encryption/decryption processing section performs the encryption or decryption processing for the (K+1)th divided data of the first content data by using the processing result or the input value.

2. The encryption/decryption device as defined in claim 1,
wherein a key, an initial value, and the processing result or the input value of the encryption/decryption processing section are stored in the intermediate value storage section in content units.

3. An encryption/decryption device which performs encryption or decryption processing for divided data of first and second content data, the encryption/decryption device comprising:
a storage section which stores the divided data as input data and stores output data obtained by subjecting the input data to encryption or decryption processing;
a first encryption/decryption processing section which performs first encryption processing or first decryption processing for the divided data in an operation mode of a block cipher method using data in a block other than a block under processing;
a second encryption/decryption processing section which performs second encryption processing or second decryption processing for the divided data in an operation mode of a block cipher method using data in a block other than a block under processing; and
an intermediate value storage section which stores a block-unit processing result or an input value of the first and second encryption/decryption processing section in content units,
wherein the storage section stores decrypted data obtained by causing one of the first and second encryption/decryption processing sections to perform the first or second decryption processing for the input data;
wherein the storage section stores data obtained by causing the other of the first and second encryption/decryption processing sections to perform the first or second encryption processing for the decrypted data after the first or second encryption processing as the output data;
wherein the intermediate value storage section stores the processing result or the input value of the encryption or decryption processing performed by at least one of the first and second encryption/decryption processing sections for one of the divided data of the second content data as the input data; and
wherein the processing result or the input value of the first or second encryption/decryption processing section for the Kth (K is a natural number) divided data of the first content data is read from the intermediate value storage section, and at least one of the first and second encryption/decryption processing sections performs the encryption or decryption processing for the (K+1)th divided data of the first content data as the input data by using the processing result or the input value.

4. The encryption/decryption device as defined in claim 3,
wherein a storage area for the decrypted data in the storage section is inaccessible from outside of the encryption/decryption device.

5. An encryption/decryption device which performs encryption or decryption processing for divided data of first and second content data, the encryption/decryption device comprising:
a first storage section which is accessible from outside of the encryption/decryption device and stores the divided data as input data;
a first encryption/decryption processing section which performs first encryption processing or first decryption processing for the divided data in an operation mode of a block cipher method using data in a block other than a block under processing;
a second encryption/decryption processing section which performs second encryption processing or second decryption processing for the divided data in an operation mode of a block cipher method using data in a block other than a block under processing;
a second storage section which is inaccessible from outside of the encryption/decryption device and stores decrypted data obtained by subjecting the input data to the first or second decryption processing;
a third storage section which is accessible from outside of the encryption/decryption device and stores output data obtained by subjecting the input data to the encryption or decryption processing; and
an intermediate value storage section which stores a block-unit processing result or an input value of the encryption/decryption processing section in content units,
wherein the second storage section stores decrypted data obtained by causing one of the first and second encryption/decryption processing sections to perform the first or second decryption processing for the input data;
wherein the third storage section stores data obtained by causing the other of the first and second encryption/decryption processing sections to perform the first or second encryption processing for the decrypted data after the first or second encryption processing as the output data;
wherein the intermediate value storage section stores the processing result or the input value of the encryption or decryption processing performed by at least one of the first and second encryption/decryption processing sections for one of the divided data of the second content data as the input data; and
wherein the processing result or the input value of the first or second encryption/decryption processing section for the Kth (K is a natural number) divided data of the first content data is read from the intermediate value storage section, and at least one of the first and second encryption/decryption processing sections performs the encryption or decryption processing for the (K+1)th divided data of the first content data as the input data by using the processing result or the input value.

6. The encryption/decryption device as defined in claim 5,
wherein the first to third storage sections are respectively provided in divided storage areas in one memory space; and
wherein each of the storage areas is variable.

7. The encryption/decryption device as defined in claim 5,
wherein a key of the first encryption/decryption processing section, an initial value of the first encryption/decryption processing section, and the processing result or the input value of the first encryption/decryption processing section are stored in the intermediate value storage section in content units; and
wherein the processing result or the input value of the second encryption/decryption processing section is stored in the intermediate value storage section in content units.

8. The encryption/decryption device as defined in claim 5,
wherein a key of the first encryption/decryption processing section, an initial value of the first encryption/decryption processing section, and the processing result or the input value of the first encryption/decryption processing section are stored in the intermediate value storage section in content units; and
wherein the second encryption/decryption processing section performs the second encryption processing or the second decryption processing for the (K+1)th divided data of the first content data as the input data by using a predetermined initial value without reading the processing result or the input value of the second encryption processing or the second decryption processing for the Kth divided data of the first content data from the intermediate value storage section.

9. The encryption/decryption device as defined in claim 5,
wherein the first encryption/decryption processing section performs encryption and decryption processing compliant with the Advanced Encryption Standard (AES); and
wherein the second encryption/decryption processing section performs encryption and decryption processing compliant with the Data Encryption Standard (DES).

10. The encryption/decryption device as defined in claim 1,
wherein the operation mode is one of the cipher block chaining (CBC) mode, the cipher feedback (CFB) mode, and the output feedback (OFB) mode.

11. The encryption/decryption device as defined in claim 3,
wherein the operation mode is one of the cipher block chaining (CBC) mode, the cipher feedback (CFB) mode, and the output feedback (OFB) mode.

12. The encryption/decryption device as defined in claim 1, comprising:
a header analysis section which analyzes header information added to the input data,
wherein whether the divided data is the divided data of the first content data or the divided data of the second content data is determined based on identification information included in the header information.

13. The encryption/decryption device as defined in claim 3, comprising:
a header analysis section which analyzes header information added to the input data,
wherein whether the divided data is the divided data of the first content data or the divided data of the second content data is determined based on identification information included in the header information.

14. A communication controller for transmitting and receiving communication data having a layered structure through a network, the communication controller comprising:
a communication processing section which performs transmission processing and reception processing of the communication data; and
the encryption/decryption device as defined in claim 1 which performs the encryption or decryption processing for the communication data to be transmitted to the network or the communication data received from the network.

15. A communication controller for transmitting and receiving communication data having a layered structure through a network, the communication controller comprising:
a communication processing section which performs transmission processing and reception processing of the communication data; and
the encryption/decryption device as defined in claim 3 which performs the encryption or decryption processing for the communication data to be transmitted to the network or the communication data received from the network.

16. A communication controller for transmitting and receiving communication data having a layered structure through a network, the communication controller comprising:
a communication processing section which performs transmission processing and reception processing of the communication data; and
the encryption/decryption device as defined in claim 3,
wherein, when the communication data is received, the communication processing section analyzes header information, and the encryption/decryption device performs the first decryption processing and then the second encryption processing for data in a layer higher than a layer of the header information as the input data, and then outputs the data as the output data, the first encryption processing having been performed for the data before reception; and
wherein, when the communication data is to be transmitted, the encryption/decryption device performs the second decryption processing and then the first encryption processing for data to be transmitted as the input data, and then outputs the data as the output data, the communication processing section adds higher-layer header information to the output data, and then the communication controller transmits the resulting output data to the network.

17. An electronic instrument comprising:
the communication controller as defined in claim 14; and
a processing section which supplies divided content data to the communication controller.

18. An electronic instrument comprising:
the communication controller as defined in claim 15; and
a processing section which supplies divided content data to the communication controller.

19. An electronic instrument comprising:
the communication controller as defined in claim 16; and
a processing section which supplies divided content data to the communication controller.

20. An electronic instrument comprising:
the communication controller as defined in claim 16; and
a processing section which generates divided content data and performs the second encryption processing and the second decryption processing,
wherein, when the communication data is received, the communication controller supplies data after the second encryption processing to the processing section; and
wherein, when the communication data is to be transmitted, the processing section supplies data after the second encryption processing to the communication controller as the input data.
